(19) United States
(12) Patent Application Publication
(10) Pub. No.: US 2024/0339644 A1
(43) Pub. Date: Oct. 10, 2024

(54) Symmetric Redox Molecules Using Synergistic Electron Directing Pairs

(71) Applicant: ExxonMobil Technology and Engineering Company, Annandale, NJ (US)

(72) Inventors: Divyaraj Desai, Stewartsville, NJ (US); Ross Mabon, Whitehall, PA (US); Jordan N. Metz, Doylestown, PA (US); Satish Bodige, Wayne, NJ (US); Latoya S. Chambers, Irvington, NJ (US); Jonathan D. Saathoff, Three Bridges, NJ (US)

(73) Assignee: ExxonMobil Technology and Engineering Company, Annandale, NJ (US)

(21) Appl. No.: 18/597,482

(22) Filed: Mar. 6, 2024

Related U.S. Application Data
(60) Provisional application No. 63/456,198, filed on Mar. 31, 2023.

(51) Int. Cl. H01M 8/18; H01M 8/24

(52) U.S. Cl. CPC H01M 8/188; H01M 8/24

(57) ABSTRACT

Disclosed herein are a variety of systems, compositions, and methods for reversibly storing electrical energy in a symmetric redox flow battery with a unit cell potential equal to or greater than 3 volts. The systems include a conjugated organic molecule, a positive section, and a negative section. The conjugated organic molecule comprises a pair of electron-donating groups and a pair of electron-withdrawing groups, wherein a first electron-donating group of the electron donating groups is one ring position from a first electron-withdrawing group of the electron-withdrawing groups, and wherein a second electron-donating group is one ring position from a second electron-withdrawing group of the electron-withdrawing groups. The positive section includes a first metal electrode in contact with a catholyte comprising a portion of the conjugated organic molecule. The negative section comprises a second metal electrode in contact with an anolyte including an additional portion of the conjugated organic molecule.

### CROSS-REFERENCE TO RELATED APPLICATIONS

This application claims priority to U.S. Provisional Application No. 63/456,198 filed Mar. 31, 2023, the disclosure of which is incorporated by reference in its entirety.

### FIELD

This disclosure relates to electrochemical energy storage comprising high-voltage multivalent organic molecules, methods of producing these molecules, and redox flow battery systems utilizing these molecules for energy storage.

### BACKGROUND

Renewable energy sources, such as wind and solar power, provide intermittent energy that does not coincide with peak load times all the time. Thus, there is a need for large scale energy storage integrated into the electric grid. Redox flow batteries are capable of storing large amounts of energy by converting electrical energy into electrochemical potential energy. The stored electrochemical energy can be converted back into electrical energy upon discharge with reversal of the opposite redox reactions.

Redox flow batteries, also called semi-fuel cells, are powered by electroactive species dissolved in liquid electrolyte solutions: a catholyte and an anolyte. The liquid electrolyte solutions may be stored in large tanks and flowed through parallel plates between current collectors and an ion selective membrane. The energy storage capacity may be determined by the number of moles of redox-active species, while the power output is determined by the active area of the electrochemical stack. Therefore, redox flow batteries have the unique benefit of independent power and energy scaling. This attribute is particularly advantageous for longer duration energy storage, wherein the cost of storage is primarily driven by the fluid cost.

Typical redox flow battery system includes one or more redox-active species, an optional supporting electrolyte and an optional solvent and a stack comprising one or more electrochemical cells. The electrochemical stack comprises current collectors, optional high-surface area electrodes, optional ion-selective membranes or porous separators and an optional fluid transport device, such as a peristaltic pump.

Most redox flow batteries utilize dissimilar redox species at the anode electrolyte (anolyte) and at the cathode electrolyte (catholyte). This results in a concentration gradient of each redox-active species on either side of the ion-transport membrane or porous separator, resulting in a steady flux in the diffusion of the redox-active species, i.e., anolyte into the catholyte half-cell and vice versa. This diffusive redox-active species flux is referred to as redox crossover and can result in considerable loss of battery capacity during typical operation.

### SUMMARY

Disclosed herein is a system for energy storage including a conjugated organic molecule, a positive section, and a negative section. The conjugated organic molecule comprises a pair of electron-donating groups and a pair of electron-withdrawing groups, wherein a first electron-donating group of the electron donating groups is one ring position from a first electron-withdrawing group of the electron-withdrawing groups, and wherein a second electron-donating group is one ring position from a second electron-withdrawing group of the electron-withdrawing groups. The positive section includes a first metal electrode in contact with a catholyte comprising a portion of the conjugated organic molecule and a supporting electrolyte dissolved in an solvent. The negative section comprises a second metal electrode in contact with an anolyte including an additional portion of the conjugated organic molecule and additional electrolyte dissolved in additional solvent.

Further disclosed herein is a composition including a multivalent redox-active organic molecule in a supporting electrolyte. The multivalent redox active organic molecule comprises a pair of electron-donating groups and a pair of electron-withdrawing groups, wherein a first electron-donating group of the electron donating groups is one ring position from a first electron-withdrawing group, and wherein a second electron-donating group is one ring position from a second electron-withdrawing group.

Disclosed herein is also a method for reversibly storing electrical energy in a symmetric redox flow battery with a unit cell potential equal to or greater than 3 volts. The method includes flowing a catholyte into contact with a first metal electrode in a positive section of the redox flow battery, wherein the catholyte comprises a single species of a conjugated organic molecule dissolved in a solvent, wherein the conjugated organic molecule comprises a pair of electron-donating groups and a pair of electron-withdrawing groups, wherein a first electron-donating group of the electron donating groups is one ring position from a first electron-withdrawing group, and wherein a second electron-donating group is one ring position from a second electron-withdrawing group. The method further includes flowing an anolyte into contact with a second metal electrode in a negative section of the redox flow battery, wherein the negative section is separated from the positive section with an ion-transporting membrane, wherein the anolyte comprises an additional portion of the organic molecule dissolved in additional solvent; and supplying electrical energy to the first metal electrode and the second metal electrode while an external load is not in electrical communication with the first metal electrode and the second metal electrode to charge the redox flow battery while flowing the catholyte and flowing the anolyte.

These and other features and attributes of the disclosed methods and systems of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings.

FIG. 1 is a cyclic voltammogram of 5 mM p-benzoquinone+0.1 M N-tetrabutylammonium hexafluorophosphate (TBAPF₆) in acetonitrile (100 mV/s) between −2.0 V to +0.5 V, wherein the redox potentials, E_{1/2}, are at −1.599 V and −0.846 V.

FIG. 2 is a cyclic voltammogram of 5 mM p-dimethoxybenzene+0.1 M N-tetrabutylammonium hexafluorophosphate (TBAPF₆) in acetonitrile (100 mV/s) between +0.5 V to +1.25 V.

FIG. 3 is a cyclic voltammogram of 5 mM o-1,2-dicyanobenzene+0.1 M N-tetrabutylammonium hexafluorophosphate (TBAPF₆) in acetonitrile (100 mV/s) between −2.5 V to +0.5 V.

FIG. 4A is a cyclic voltammogram of 5 mM 3,6-dimethoxy-1,2-dicyanobenzene+0.1 M TBAPF₆ in acetonitrile at 100 mV/s between −2.5 to +1 V (1) and between +1 V to 1.85 V (2).

FIG. 4B is a cyclic voltammogram of 5 mM 3,6-dimethoxy-1,2-dicyanobenzene+0.1 M TBAPF₆ in acetonitrile at 250 mV/s between −3 to +1 V (1) and +1 to 1.85 V (2).

FIG. 5 is a schematic of a membrane characterization setup to assess redox permeability and membrane ionic conductivity of one or more embodiments.

FIG. 6 is a schematic of a membrane characterization setup to assess redox permeability and membrane ionic conductivity of one or more embodiments.

FIG. 7A are traces of the linear scanning voltammograms recorded with the membrane characterization setup of FIG. 5 recorded every hour at a scan rate of 25 mV/s within the voltage range 0 V to 0.6 V vs Ag|10 mM AgNO₃.

FIG. 7B is the room temperature MEEPT permeability in acetonitrile for a limited set of anion exchange membranes.

FIG. 8 is a cyclic voltammogram of 5 mM N, N′,N′-tetramethyl-p-phenylenediamine+0.1 M N-tetrabutylammonium hexafluorophosphate (TBAPF₆) in acetonitrile between −0.35 V to +0.1 V.

FIG. 9 is a cyclic voltammogram (100 mV/s) of 5 mM o-dicyanobenzene+0.1 M N-tetrabutylammonium hexafluorophosphate (TBAPF₆) in acetonitrile between −2.5 to +1 V.

FIG. 10 is a cyclic voltammogram (100 mV/s) of 5 mM 6,7-difluoro-1,4-dimethyl-1,4-dihydroquinoxaline-2,3-dione+0.1 M N-tetrabutylammonium hexafluorophosphate (TBAPF₆) in acetonitrile between −2.6 V to +1.6 V.

FIG. 11 is a cyclic voltammogram (100 mV/s) of approximately 5 mM N, N′-diethylphthalhydrazide+0.1 M N-tetrabutylammonium hexafluorophosphate (TBAPF₆) in acetonitrile between −2.5 V to +1.5 V.

FIG. 12 is a cyclic voltammogram (100 mV/s) of 5 mM phthalhydrazide derivative +0.1 M N-tetrabutylammonium hexafluorophosphate (TBAPF₆) in acetonitrile between −2.5 V to +1.7 V.

FIG. 13 is a cyclic voltammogram (100 mV/s) of 5 mM 3,6-dibutoxyphthalonitrile +0.1 M N-tetrabutylammonium hexafluorophosphate (TBAPF₆) in acetonitrile between −2.5 V to +1.75 V.

FIG. 14A is the cell potential and current obtained as a function of time for the first cycle of a 10 mM 1,4-dimethoxy-2,3-dicyanobenzene symmetric flow battery.

FIG. 14B is the cell potential and current obtained as a function of time for 50 cycles of a 10 mM 1,4-dimethoxy-2,3-dicyanobenzene symmetric flow battery.

FIG. 15A is the cell potential and current obtained as a function of time for the first 100 cycles of a 25 mM diethyl 2,5-diethoxy terephthalate symmetric flow battery.

FIG. 15B is the discharge capacity fade and coulombic efficiency obtained as a function of cycle numbers for the first 100 cycles of a 25 mM diethyl 2,5-diethoxy terephthalate symmetric flow battery.

### DETAILED DESCRIPTION

This application relates to redox flow batteries and, more particularly, embodiments relating to redox electrochemical systems comprising conjugated organic and multivalent symmetric redox molecules comprising a pair of electron-donating groups and a pair of electron-withdrawing groups and methods of identifying these systems. The molecular screening methods identify conjugated, symmetric redox molecules comprising a pair of electron-donating groups and a pair of electron-withdrawing groups that result in high electrochemical cell potential by the synergistic pairing of the electron-directing substituent pairs. A symmetric redox species is a multivalent species, where the individual redox reactions are separated by sufficiently high electrochemical cell potential. High electrochemical cell potential is defined in this disclosure as a cell potential equal to, or above, 2 V and up to 5 V (or even 10 V) included.

Symmetric redox-active species utilizing multiple redox states of a transition metal have been reported in the literature. The vanadium redox flow battery is the most well-known of these systems and utilizes a [VO]⁺²|[VO₂]⁺ redox couple as the anolyte, and a V⁺²|V⁺³ couple as the catholyte. While this chemistry is capable of achieving very long cycle life (e.g., >10,000 cycles), the thermodynamic cell potential and resulting energy density is quite low.

TABLE 1
Reactions in a Symmetric Vanadium Redox Flow Battery.

| | Redox potential |
|---|---|
| Electrochemical reaction | (V vs SHE) |
| V²⁺ [symbol] V³⁺ + e⁻ | −0.26 |
| [VO]²⁺2H⁺ + e⁻ [symbol] [VO₂]⁺ + H₂O | +1.00 |

In contrast, the systems of the present disclosure, which include symmetric redox flow batteries based on organic molecules, comprising a pair of electron-donating groups and a pair of electron-withdrawing groups, achieve much higher voltages than the aqueous alternative by suppressing solvent decomposition. For example, aqueous systems are limited by water electrolysis, which is initiated at potentials above 1.22 V. Symmetric operation is achieved by using electron-directing substituents to perturb the delocalized electron density of conjugated compounds such as benzene or quinoxaline.

In one or more embodiments, the multivalent redox-active organic molecule has a pair of diketone substituents and comprises a pair of electron-donating groups and a pair of electron-withdrawing groups. For instance, a first electron-donating group of the electron donating groups is one ring position from a first electron-withdrawing group while a second electron-donating group is one ring position from a second electron-withdrawing group. In other embodiments, a first electron-donating group of the electron donating groups may not have any spacing from a first electron-withdrawing group while a second electron-donating group is also next to a second electron-withdrawing group. In other examples, a first electron-donating group of the electron donating groups is two ring position from a first electron-withdrawing group while a second electron-donating group is next to a second electron-withdrawing group.

As used herein, electron-donating groups are electron-directing groups that add to the electron density of a conjugated molecule. Examples of electron-donating groups include alkoxy (—OCₙH₂ₙ₊₁), amino (—NH₂), alkylamino (—NHCₙH₂ₙ₊₁), dialkylamino [—N(CₙH₂ₙ₊₁)₂], acyloxy, dialkylphosphino, and alkylthio functional groups. In some instances, at least one of the electron-donating groups is a heteroatom (e.g., nitrogen, phosphorous, sulfur) that participates in the conjugated system.

As used herein, electron-withdrawing groups are electron-directing groups that remove electron density from a conjugated molecule. Examples of electron-withdrawing groups include trifluoromethylsulfonyl (—SO₂CF₃), nitro (—NO₂), trihalomethyl, acyl, cyano(—CN), isocyanate (—N═C═O), sulfone (—SO₂), sulfoxide (—S═O), alkylsulfonyl (—SO₂CₙH₂ₙ₊₁), haloformyl (COX), acyl(COCₙH₂ₙ₊₁), aminocarbonyl, alkylaminocarbonyl (CONHCₙH₂ₙ₊₁), dialkylaminocarbonyl [CON(CₙH₂ₙ₊₁)₂], or alkoxycarbonyl (—COOCₙH₂ₙ₊₁) functional groups. In some instances, at least one of the electron-withdrawing groups is a heteroatom (e.g., nitrogen, phosphorous, sulfur) that participates in the conjugated system.

As used herein, the chemical structure CₙH₂ₙ₊₁ refers to a saturated alkyl substituent with n being from 1 to 20.

As used herein, the chemical structure (CₙH₂ₙ₊₁)₂ refers to a saturated alkyl substituent with n being from 1 to 20, which may be of dissimilar carbon length or chemical structure.

As used herein, a halogen indicated in a chemical formula by X refers to fluorine (F), chlorine (Cl), bromine (Br) or iodine (I).

### Conjugated Molecules

With conjugated molecules, the anolyte and catholyte reactions are linked within a conjugated system comprising a pair of electron-donating groups and a pair of electron-withdrawing groups, such as the molecule shown below:

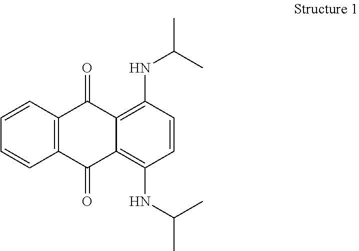 [SMILES: CC(C)Nc1ccc(NC(C)C)c2c1C(=O)c1ccccc1C2=O]

A conjugated system refers to a molecular structure or substructure of alternating single and double bonds that allows for electron delocalization through overlap of p-orbitals. The sharing of the p-orbitals in the conjugated system of alternating double and single bonds results in the delocalization of electron density across the entire conjugated sub-system stabilizing it against further attack. Consequently, electrochemical reactions in aprotic solvents are able to proceed with the formation of radical ions and subsequent dimerization. As an example, an electrochemical reduction reaction may proceed with the formation of a radical anion (Reaction 1 below) followed by subsequent dimerization (Reaction 2 below), as illustrated in the following reactions:

[A]+e⁻ [symbol] [A]^{·-} Reaction 1

2[A]^{·-} [symbol] [A₂]²⁻ Reaction 2

As an example, an electrochemical oxidation reaction may proceed with the formation of a radical cation (Reaction 3) followed by subsequent dimerization (Reaction 4), as illustrated in the following reaction:

[C] [symbol] [C]^{·+}+e⁻ Reaction 3

2[C]^{·+} [symbol] [C₂]²⁺ Reaction 4

The thermodynamic potential at which these reactions occur is dependent on the electron density of the conjugated system and the stability is dependent on the extent of electron delocalization. The electron density and delocalization can be altered by the use of pairs of electron-directing substituent groups. Electron-directing groups influence the redox activity of a conjugated system through the mesomeric effect and the inductive effect. As a result of the mesomeric influence, a substituent can influence whether the electron density is shared over a larger conjugated structure and a larger set of resonance structures. The inductive effect influences whether a given molecule can add or reduce electron density without changing the conjugated structure. Substituent groups can swing the redox activity of a molecule to increasingly positive or negative values, which could result in promising redox chemistries for a redox flow battery application. There can be an inhibitory mechanism, wherein electrochemical charge-transfer is impeded until the electron-directing influence of a substituent is overcome. An electron withdrawing substituent reduces the electron density of the conjugated system, which enables the electrochemical charge-transfer reaction to occur at more negative potential. By contrast, the use of an electron donating substituent pair allows the shifts of the electrochemical charge-transfer reaction to more positive values.

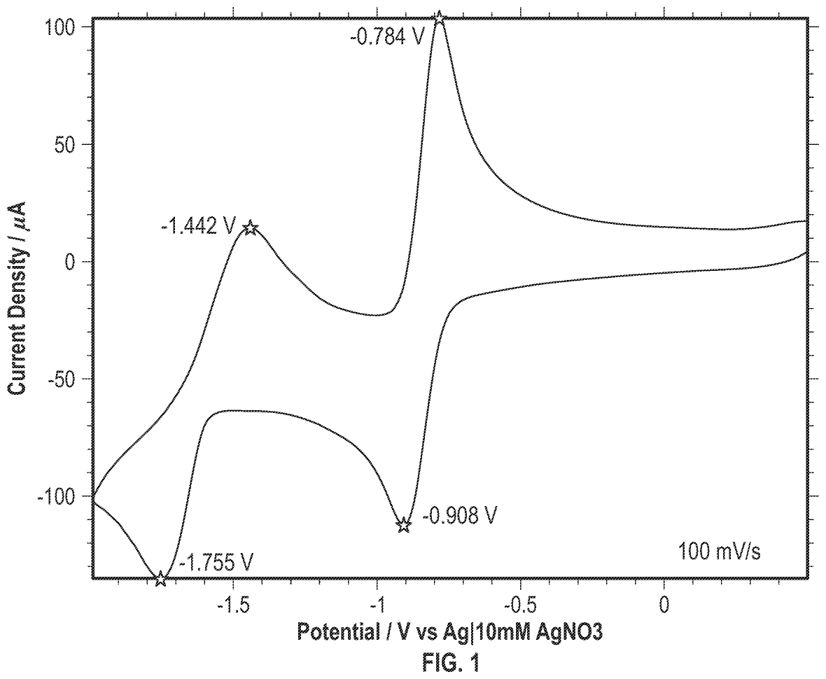

Cyclic voltammetry is a powerful and popular electro-chemical technique commonly employed to investigate the reduction and oxidation processes of molecular species. A cyclic voltammogram is acquired for each redox-active species, the oxidative peak and reductive peak recorded, and the halfway potential between the two observed peaks, E_{1/2}, calculated. All reported E_{1/2} values are measured against a silver/silver nitrate reference electrode (Ag|10 mM AgNO₃ in acetonitrile), whose potential is −0.09 V versus a ferrocene couple (Fc|Fc⁺). As an example, the use of a pair of electron-withdrawing ketone-substituents results in a molecule, p-benzoquinone, with a highly reversible analytic reaction as shown in FIG. 1 with the cyclic voltammogram of 5 mM p-benzoquinone+0.1 M N-tetrabutylammonium hexafluorophosphate (TBAPF₆) in acetonitrile (100 mV/s), wherein the redox potentials, E_{1/2}, are at −1.596 V and −0.846 V, respectively. However, the resulting difference in half-cell potentials (0.750 V) is unsatisfactory for an energy storage device.

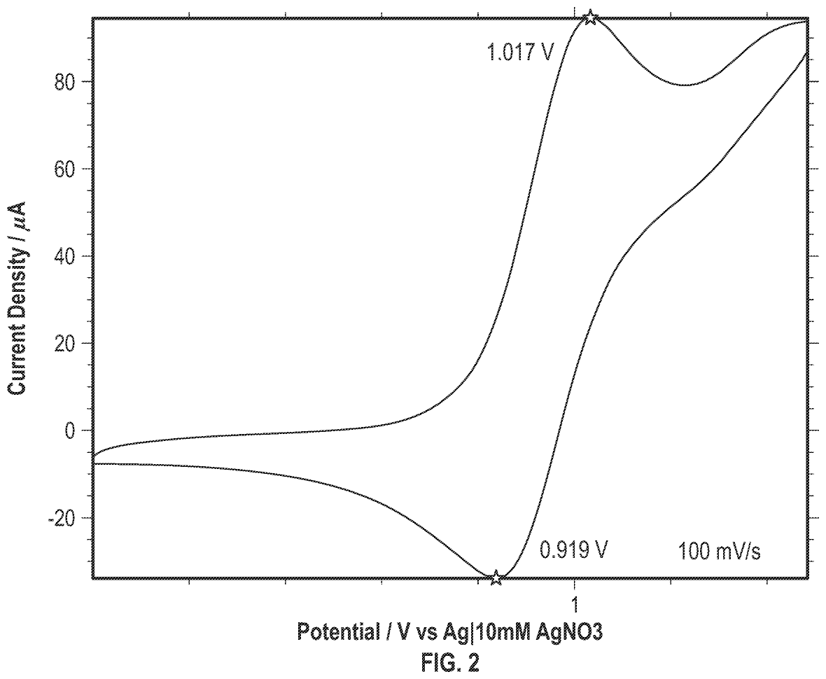

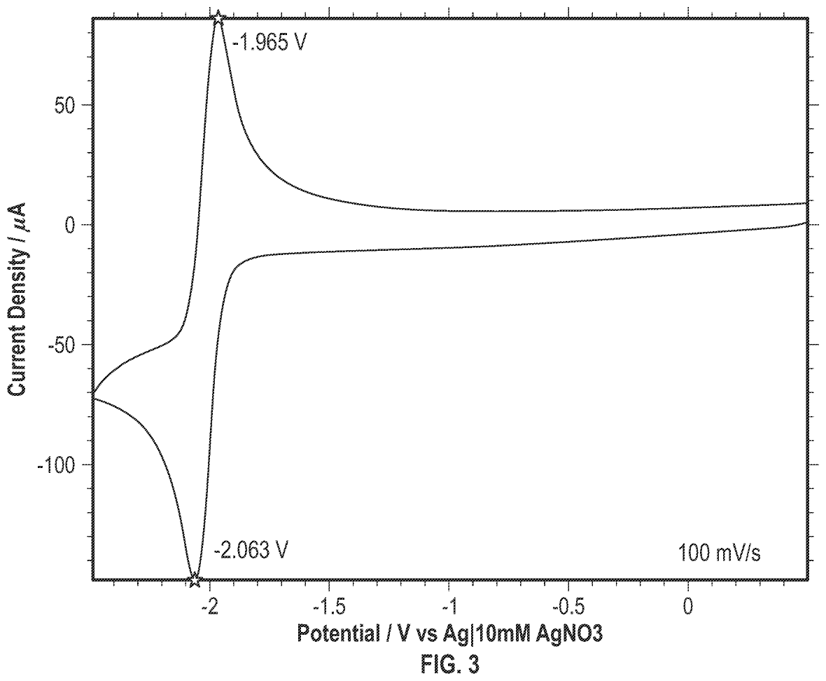

An appropriately located electron-withdrawing substituent pair with a withdrawing mesomeric effect and withdrawing inductive effect can be demonstrated to result in a redox-active anolyte. In contrast, an appropriately located electron-donating substituent pair with an electron-donating mesomeric effect and an electron-donating inductive effect can be demonstrated to result in a redox-active catholyte. For instance, the attachment of a pair of electron-donating methoxy-substituents to benzene results in a molecule p-dimethoxybenzene with a highly reversible catholytic reaction with redox potential, E_{1/2}, at +0.968 V as illustrated in FIG. 2 with the cyclic voltammogram of 5 mM p-dimethoxybenzene+0.1 M N-tetrabutylammonium hexafluorophosphate (TBAPF₆) in acetonitrile (100 mV/s). Conversely, the attachment of pair of electron-withdrawing cyano-substituents attached to benzene results in a molecule o-dicyanobenzene with an electrochemically reversible analytic reaction with a redox potential, E_{1/2}, at −2.014 V as illustrated in FIG. 3 with a cyclic voltammogram of 5 mM o-dicyanobenzene+0.1 M N-tetrabutylammonium hexafluorophosphate (TBAPF₆) in acetonitrile (100 mV/s) between −2.5 V to +0.5 V.

An exemplary asymmetric redox flow system comprising the p-dimethoxybenzene and o-dicyanobenzene redox couples can be demonstrably predicted to have an open circuit voltage of +2.979 V based on the electrochemical half-cell potentials reported above. However, despite the good redox potential, this asymmetric system would be susceptible to redox crossover issues. Instead, a symmetric couple of molecules can be produced by the pairing of these substituents in the same conjugated structure. When this is done with the exemplary molecules listed above, the molecule 3,6-dimethoxy-1,2-dicyanobenzene can be demonstrated to be redox-active and symmetric, with E₁/2 values of −1.957 V and 1.579 V respectively.

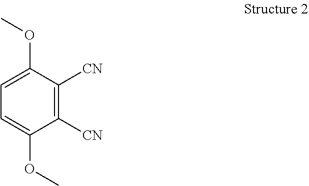

Structure 2 has a pair of electron-donating groups through the methoxy groups and a pair of electron-withdrawing groups through the cyano groups.

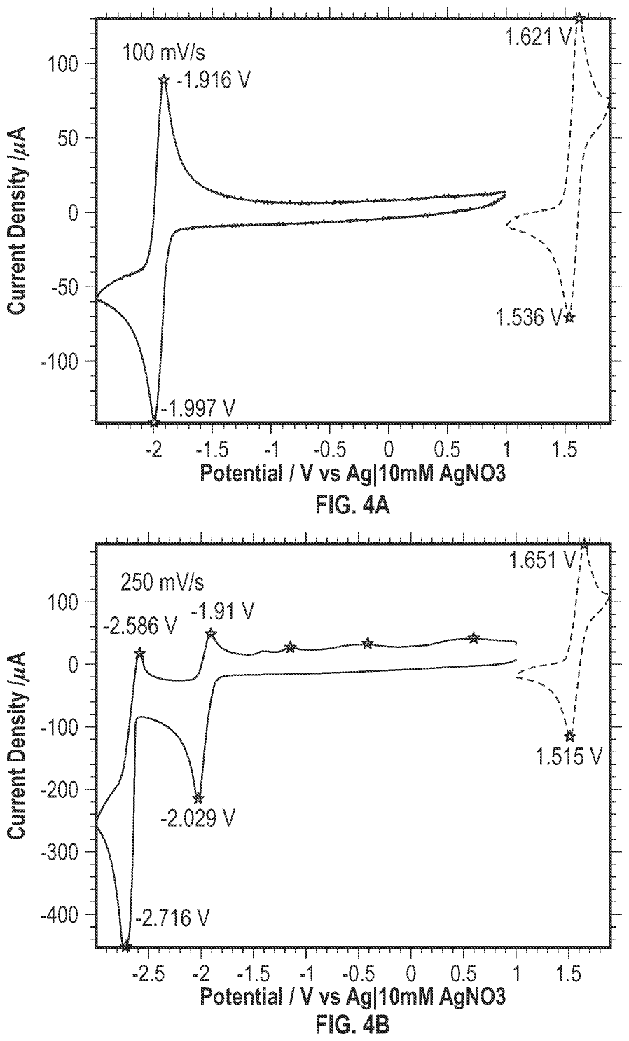

The cyclic voltammogram in FIG. 4A of 5 mM 3,6-dimethoxy-1,2-dicyanobenzene+0.1 M N-tetrabutylammonium hexafluorophosphate (TBAPF₆) in acetonitrile (100 mV/s) validates the electrochemical reversibility of this molecule.

Also evident from FIG. 4A, the redox potential of the oxidation reaction can be significantly higher (+0.556 V) than p-dimethoxybenzene by the synergistic pairing of electron-directing groups to the same conjugated system, as evidenced by the higher cell potential of the symmetric molecule (3.535 V) compared to the asymmetric case (2.979 V). A significant shift is defined herein by a thermodynamic potential change, ΔE_{cell}, above 0.1 V. This may be explained by the following mechanism taking a substituted aromatic molecule as illustrated below as example:

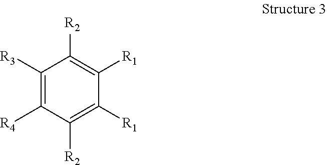

wherein R₁ is an electron-donating group, R₂ is an electron-withdrawing group, R₃ and R₄ are optional non-electron-directing substituents that may be used to lower melting point and improve solubility. Examples of R₃ and R₄ include alkyl, aromatic, glycol, or halogen (fluoro-, chloro-, iodo- or bromo-) groups. In some embodiments, R₃ and R₄ may be used individually or may be the same group.

A pair of electron-withdrawing substituents, R₂, deplete the electron density from the conjugated system, in particular, at the atom located ortho- or para- to it. Consequently, the catholytic reaction occurring on account of an electron donating group is pushed to increasingly positive potentials. A pair of electron-donating substituents, R₁, adds to the electron density in the conjugated system, in particular, at the atom located ortho- or para- to it. Consequently, the analytic reaction occurring on account of an electron donating group is pushed to increasingly negative potentials. The potential shift due to synergistic pairing may benefit either catholytic or analytic reactions, or both. In some embodiments, substituents R₃ and R₄ may be added as necessary to improve electrochemical reversibility or solubility. The common feature is that R₃ and R₄ are not strongly directing. These groups may be the same, or dissimilar groups can be paired.

The maximum achievable voltage using any organic symmetric molecule has previously been limited to 2.84 V for 1,4-bis(dimethylamino)-9,10-anthraquinone. However, the use of electron directing groups on different rings results in increased molecular weight and limits the synergistic benefit of strongly electron directing groups proximally to each other. As such, a mechanism to achieve a high redox voltage symmetric molecule (E_{cell}>3 V) cannot be achieved based on the symmetric molecules that have been previously identified. In one or more embodiments, symmetric molecules belonging to the following chemotypes are identified, synthesized, and demonstrated to be redox-active with cell potentials far exceeding those of the symmetric organic molecules previously identified, namely (1) heterocyclic quinonoids, (2) substituted benzenes, (3) diazenes, and (4) tetrazines.

Any suitable technique may be used for the preparation of these symmetric molecules. In one or more embodiments, the symmetric redox molecules were classified by chemotypes: substituted aromatics, substituted quinones, heterocyclic quinonoids, substituted di-heterocycles, and tetra-heterocycles.

### Substituted Aromatics

In some embodiments, the organic compound of the present disclosure comprises a substituted aromatic. Example substituted aromatics are represented by conjugated organic compounds containing at least one pair of electron-donating groups, represented by R₁ in the chemical structure below and at least one pair of electron-withdrawing groups, represented by R₂:

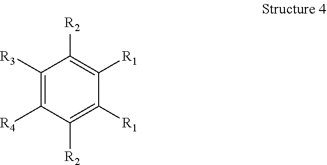

wherein R₁ is an electron-donating group, R₂ is an electron-withdrawing group, R₃ is not strongly electron directing, and R₄ is not strongly electron directing. The conjugated organic system in the chemotype may include one or two rings that contain at least one carbon-carbon double bond (C═C). Additional weakly or non-electron-directing substituents may be optionally included, represented as R₃ and R₄ in the chemical structure above.

In some embodiments, the organic compound comprises a substituted aromatic represented by the structure below.

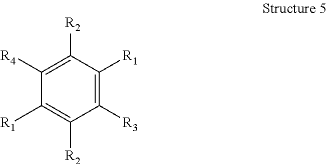

wherein R1 is an electron-donating group, R2 is an electron-withdrawing group, R3 is not strongly electron directing, and R4 is not strongly electron directing. The conjugated organic system in the chemotype may include one or two rings that contain at least one carbon-carbon double bond (C═C). Additional weakly or non-electron-directing substituents may be optionally included, represented as R3 and R4 in the chemical structure above. Examples of R₃ and R₄ include alkyl, aromatic, glycol, or halogen (fluoro-, chloro-, iodo- or bromo-) groups. In some embodiments, R₃ and R₄ may be used individually or may be the same group.

The synergistic pairing of electron-directing substituent pairs leads to high electrochemical cell potential, including above 2 V or above 3 V with embodiments of the substituted aromatics having an electrochemical cell potential up to 4.5 V.

### Substituted Quinones

In some embodiments, the organic compound of the present disclosure comprises substituted quinones. Example substituted quinones are represented by conjugated organic compounds containing at least one pair of carbon-oxygen double bonds (—C═O) and at least one pair of electron-donating substituents, represented by R1 in the generic chemical structures below:

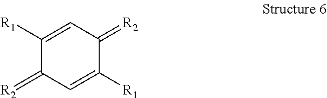

wherein R₁ is an electron-donating group and R₂ is oxygen for instance.

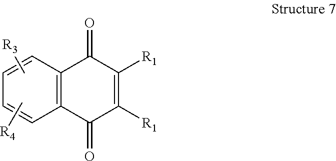

wherein R₁ is an electron-donating group, R₃ is not strongly electron directing, and R₄ is not strongly electron directing. In Structure 7, the electron-withdrawing groups are the carbon-oxygen double bonds.

The compounds in the chemotype may include one or two rings that contain at least one C═C double bond. As illustrated in Structure 7, additional weakly or non-electron-directing substituents may be optionally included, represented as R₃ and R₄. Examples of R₃ and R₄ include alkyl, aromatic, glycol, or halogen (fluoro-, chloro-, iodo- or bromo-) groups. In some embodiments, R₃ and R₄ may be used individually or may be the same group.

### Heterocyclic Quinonoids

In some embodiments, the organic compound of the present disclosure comprises a heterocyclic quinonoid. Examples of heterocyclic quinonoids are represented by conjugated organic compounds containing two similar heteroatoms, including nitrogen (N), sulfur (S), phosphorus (P) and at least one pair of carbon-oxygen double bonds (—C═O) as illustrated by the generic chemical structures (8 and 9) below:

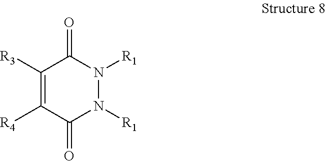

wherein —C═O is an electron-withdrawing group, N—R₁ is an electron-donating group, R₃ is not strongly electron directing, and R₄ is not strongly electron directing. The positions represented by nitrogen can be replaced by phosphorus or sulfur.

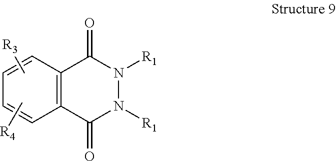

wherein —C═O is an electron-withdrawing group, N—R₁ is an electron-donating group, R₃ is not strongly electron directing, and R₄ is not strongly electron directing. The positions represented by nitrogen can be replaced by phosphorus or sulfur.

The compounds in the chemotype may include one or two rings that contain at least one C═C double bond. As appropriate, the heteroatom may also be responsible for the electron density of the conjugated system. Additional weakly or non-electron-directing substituents may be optionally included, represented as R₃ and R₄ in Structures 8 and 9. Examples of R₃ and R₄ include alkyl, aromatic, glycol, or halogen (fluoro-, chloro-, iodo- or bromo-) groups. In some embodiments, R₃ and R₄ may be used individually or may be the same group. The synergistic pairing of electron-directing substituent pairs leads to high electrochemical cell potential including above 2 V or above 3 V with embodiments of the heterocyclic quinonoids having an electrochemical cell potential up to 4.5 V.

### Substituted Di-Heterocycles

In some embodiments, the organic compound of the present disclosure comprises a substituted di-heterocycles. Example of substituted di-heterocycles are represented by conjugated organic compounds containing two heteroatoms, including nitrogen (N), sulfur (S), and phosphorus (P). The positions represented by nitrogen can be replaced by phosphorus compounds. The compounds in the chemotype may include one or two rings that contain at least one carbon-carbon double bond (C═C) as illustrated by the generic chemical structures below:

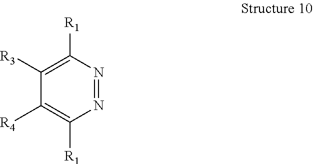

wherein R₁ is an electron-donating group, the nitrogen atoms of the heterocycle are the electron-donating groups, R₃ is not strongly electron directing, and R₄ is not strongly electron directing. The positions represented by nitrogen can be replaced by phosphorus or sulfur.

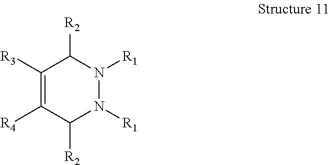

wherein the N—R₁ group is an electron-donating group, R₂ is an electron-withdrawing substituent, R₃ is not strongly electron directing, and R₄ is not strongly electron directing. The positions represented by nitrogen can be replaced by phosphorus or sulfur.

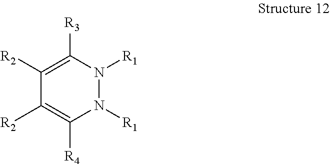

wherein the N—R₁ group is an electron-donating group, R₂ is an electron-withdrawing substituent, R₃ is not strongly electron directing, and R₄ is not strongly electron directing. The positions represented by nitrogen can be replaced by phosphorus or sulfur.

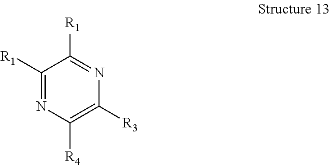

wherein R₁ is an electron-donating group, the nitrogen atoms of the heterocycle are electron-withdrawing groups, R₃ is not strongly electron directing, and R₄ is not strongly electron directing. The positions represented by nitrogen can be replaced by phosphorus or sulfur.

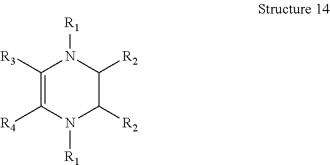

wherein the N—R₁ group is an electron-donating group, R₂ is an electron-withdrawing substituent, R₃ is not strongly electron directing, and R₄ is not strongly electron directing. The positions represented by nitrogen can be replaced by phosphorus or sulfur.

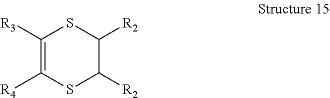

wherein the sulfur atoms of the heterocycle are electron-donating groups, R₂ is an electron-withdrawing substituent, R₃ is not strongly electron directing, and R₄ is not strongly electron directing. The positions represented by sulfur can be replaced by phosphorus or nitrogen.

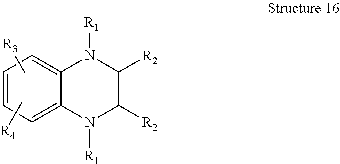

wherein the N—R₁ groups are the electron-donating groups, R₂ is an electron-withdrawing substituent, R₃ is not strongly electron directing, and R₄ is not strongly electron directing. The positions represented by nitrogen can be replaced by phosphorus or sulfur.

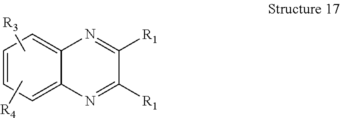

wherein R₁ is an electron-donating group, the nitrogen atoms of the heterocycle are electron-withdrawing groups, R₃ is not strongly electron directing, and R₄ is not strongly electron directing. The positions represented by nitrogen can be replaced by phosphorus or sulfur.

As appropriate, the heteroatom may also be responsible for the electron density of the conjugated system. Additional weakly or non-electron-directing substituents may be optionally included, represented as R₃ and R₄ in Structures 10 to 17. Examples of R₃ and R₄ include alkyl, aromatic, glycol, or halogen (fluoro-, chloro-, iodo- or bromo-) groups. In some embodiments, R₃ and R₄ may be used individually or may be the same group. The synergistic pairing of electron-directing substituent pairs leads to high electrochemical cell potential, including above 2 V or above 3 V with embodiments of the substituted di-heterocycles having an electrochemical cell potential up to 4.5 V and above.

### Tetra-Heterocycles

In some embodiments, the organic compound of the present disclosure comprises tetra-heterocycles. Tetra-heterocycles are represented by conjugated organic compounds containing four heteroatoms, including nitrogen (N), sulfur (S), phosphorus (P). The compounds in the chemotype may include one or two rings that contain at least one carbon-carbon double bond (C═C). One or more embodiments are illustrated in generic chemical Structures 18 and 19:

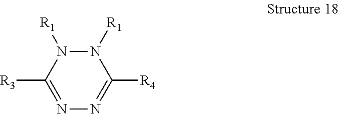

wherein the N—R₁ groups are electron-donating groups, the nitrogen atoms of the heterocycle are electron-withdrawing groups, R₃ is not strongly electron directing, and R₄ is not strongly electron directing. The positions represented by nitrogen can be replaced by phosphorus or sulfur.

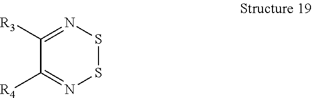

wherein the sulfurs of the heterocycle are electron-donating groups, the nitrogen atoms of the heterocycle are electron-withdrawing groups, R₃ is not strongly electron directing, and R₄ is not strongly electron directing. The positions represented by nitrogen can be replaced by phosphorus or sulfur.

In the preceding Structures 18 and 19, R1 is an electron-donating substituent, R2 is an electron-withdrawing substituent, R₃ is not strongly electron directing, and R₄ is not strongly electron directing. As appropriate, the heteroatom may also be responsible for the electron density of the conjugated system. Additional weakly or non-electron-directing substituents may be optionally included, represented as R₃ and R₄. Examples of R₃ and R₄ include alkyl, aromatic, glycol, or halogen (fluoro-, chloro-, iodo- or bromo-) groups. In some embodiments, R₃ and R₄ may be used individually or may be the same group.

### Redox Flow Batteries

Flow batteries are electrochemical devices that store energy in the different oxidation states of the selected elements. Often, these elements are soluble and exist as ions dissolved in an acidic solvent. The principle of operation for flow batteries is similar to that of conventional batteries, where oxidation and reduction reactions at two electrodes enables electrons to flow. The difference with a flow battery is the manner in which the reactants are stored. Flow batteries typically include two electrodes, a separator, and an electrolyte. However, the reactants are stored as dissolved ions in a solution, rather than physically incorporated into the electrode. As such, the reactant solutions for flow batteries can be stored in tanks, and then the solutions can be pumped through a cell where the reactions will occur to generate electricity.

In one or more embodiments, the redox flow battery of the present disclosure includes: a single species of organic molecules with at least one redox state, wherein the organic molecule comprises a pair of electron-donating groups and a pair of electron-withdrawing groups; a positive portion containing a first metal electrode in contact with a catholyte including the organic molecule dissolved in a first solvent; a negative portion containing a second metal electrode in contact with an anolyte include the organic molecule dissolved in a second solvent; and a separator for separating the positive portion from the negative portion. The redox flow battery can further include catholyte and anolyte tanks holding the catholyte and anolyte, respectively. A catholyte pump can be used to circulate catholyte from the catholyte tank to the positive portion while an anolyte pump circulates the anolyte from the anolyte tank to the negative portion. The redox flow battery can further include a load for directing electrical energy into or out of the redox flow battery.

The electrolyte solutions contain the organic molecule with at least one redox state dissolved in a solvent. For instance, the electrolyte containing the redox organic molecule in one or more redox states may also comprise one or more solvents and one or more ionically dissociative compounds as the supporting electrolyte. The solvent can be any solvent that is non-reactive with the redox active organic molecule and permits the redox active organic molecule to efficiently undergo redox reactions such that the energy storage system can be effectively charged and discharged. The additional solvent for the catholyte can be the same or different than the solvent for the anolyte.

The solvent of the present disclosure can be, for example, aqueous-based or non-aqueous (organic), protic or aprotic, and either polar or non-polar. The aqueous-based solvent can be, for example, water, or water in admixture with a water-soluble co-solvent. Some examples of protic organic solvents include alcohols, such as methanol, ethanol, n-propanol, isopropanol, n-butanol, sec-butanol, isobutanol, t-butanol, n-pentanol, isopentanol, 3-pentanol, neopentyl alcohol, n-hexanol, 2-hexanol, 3-hexanol, 3-methyl-1-pentanol, 3,3-dimethyl-1-butanol, isohexanol, and cyclohexanol. The protic organic solvent may alternatively be or include a carboxylic acid, such as acetic acid, propionic acid, butyric acid, or a salt thereof.

Some examples of polar aprotic solvents include nitrile solvents (e.g., acetonitrile, propionitrile, and butyronitrile), sulfoxide solvents (e.g., dimethyl sulfoxide, ethyl methyl sulfoxide, diethyl sulfoxide, methyl propyl sulfoxide, and ethyl propyl sulfoxide), sulfone solvents (e.g., methyl sulfone, ethyl methyl sulfone, methyl phenyl sulfone, methyl isopropyl sulfone, propyl sulfone, butyl sulfone, tetramethylene sulfone, i.e., sulfolane), amide solvents (e.g., N,N-dimethylformamide, N,N-diethylformamide, acetamide, dimethylacetamide, and N-methylpyrrolidone), ether solvents (e.g., diethyl ether, 1,2-dimethoxyethane, 1,2-diethoxyethane, 1,3-dioxolane, and tetrahydrofuran), carbonate solvents (e.g., propylene carbonate, ethylene carbonate, butylene carbonate, chloroethylene carbonate, fluorocarbonate solvents, dimethyl carbonate, diethyl carbonate, dipropyl carbonate, ethyl methyl carbonate, methyl propyl carbonate, and ethyl propyl carbonate), organochloride solvents (e.g., methylene chloride, chloroform, 1,1,-trichloroethane), ketone solvents (e.g., acetone and 2-butanone), and ester solvents (e.g., 1,4-butyrolactone, ethylacetate, methylpropionate, ethylpropionate, and the formates, such as methyl formate and ethyl formate). The polar aprotic solvent may also be or include, for example, hexamethylphosphoramide (HMPA), 1,3-dimethyl-3,4,5,6-tetrahydro-2(1H)-pyrimidinone (DMPU), or propylene glycol monomethyl ether acetate (PGMEA). Some examples of polar inorganic solvents include supercritical carbon dioxide, carbon disulfide, carbon tetrachloride, ammonia, and sulfuryl chloride fluoride. Some examples of non-polar solvents include the liquid hydrocarbons, such as the pentanes, hexanes, heptanes, octanes, pentenes, hexenes, heptenes, octenes, benzene, toluenes, and xylenes.

In some embodiments, the electrolyte of the present disclosure also comprises ionic salts as supporting electrolytes. A necessary attribute is that these salts dissociate ionically in the solvent and have a solubility of at least 0.1 moles per liter of solution, or 0.1 M and up to 10 M. Examples include salts containing alkali metals (Li, Na, K, Rb, Cs), quaternary ammonium, oxonium, sulfonium cations. Examples also include salts containing BF₄, trifluoromethanesulfonimide, PF₆, nitrate and halogen group anions. In yet other embodiments, the solvent and supporting electrolyte may be the same materials. Examples of these include ionic liquids containing imidazolium-, pyrrolidinium-, phosphonium-, trialkyloxonium, trialkylsulfonium cations, either alone or in admixture with a non-ionic liquid solvent.

The organic molecule of the present disclosure is present in the solvent in any suitable amount. For example, from 0.01 M to 5 M of the redox active species is present in the system.

The positive and negative electrodes may be any suitable electrode. For example, the positive and negative electrodes may be independently selected from, for example, graphite, carbon felt, glassy carbon, nickel on carbon, porous nickel sulfide, nickel foam, platinum, palladium, gold, titanium, titanium oxide, ruthenium oxide, iridium oxide, or a composite, such as a carbon-polyolefin composite, or a composite containing polyvinylidene difluoride (PVDF) and activated carbon, or a composite of platinum and titanium, e.g., platinized titanium. In some embodiments, the electrode material may include or be composed of an element selected from C, Si, Ga, In, Al, Ti, V, Cr, Fe, Co, Ni, Cu, Zr, Nb, Ta, Mo, W, Re, Ru, Os, Rh, Ir, Pd, Pt, Ag, Au, alloys thereof, degenerately-doped semiconductors thereof, and oxides thereof. The choice of electrode material may be dependent on the choice of redox active molecule, solvent, and other aspects of the redox flow battery in particular embodiments. For this reason, any of the specific classes or types of electrode materials described above may be excluded or specifically selected in particular embodiments.

The separator separates the catholyte in the positive compartment or positive section from the anolyte in the negative compartment or negative section to prevent the organic redox molecules in the positive and negative sections from intermingling with each other. However, the separator should possess a feature that permits the passage of non-redox-active species between the catholyte and anolyte. The non-redox-active species are those ionic species, well known in the art, that establish electrical neutrality and complete the circuitry in a battery, and which are included as either a supporting electrolyte or are formed during the course of the redox reactions in each compartment. In order to permit flow of non-redox-active species, the separator may be, to some extent, porous. Some examples of inorganic or ceramic compositions for the separator component include alumina, silica (e.g., glass), titania, and zirconia. Porous organic polymers that do not separate by ionic charge but rather, size exclusion, may also be used. These can work like physical barriers directing flow geometry to prevent mixing. The separator component may operate selectively or non-selectively in its ion permeability. The separator component can have any suitable thickness and hardness. In some embodiments, the separator component is in the form of a membrane.

In a particular embodiment, the separator is an ion-selective membrane. The ion-selective membrane, also known as an ion exchange membrane (IEM), can be any organic, inorganic (e.g., ceramic), hybrid, or composite membranes known in the art, such as those used in redox flow batteries of the art and suitable for the purposes of the invention described herein. The ion-selective membrane should substantially or completely block passage of the redox active molecule between positive and negative compartments while permitting the flow of solvent molecules and/or ion species that may evolve or be present during the electron transport process, such as hydrogen ions, halide ions, or metal ions. In some embodiments, the ion-selective membrane is a cation-selective membrane, while in other embodiments, the ion-selective membrane is an anion-selective membrane. The ion-selective membrane can include or be composed of, for example, poly(ether ether ketone) (PEEK) or sulfonated version thereof (SPEEK), poly(phthalazinone ether sulfone) (PPES) or sulfonated version thereof (SPPES), poly(phthalazinone ether sulfone ketone) (PPESK) or sulfonated version thereof (SPPESK), or an ionomer, which may be a proton conductor or proton exchange membrane, particularly a fluoropolymer (e.g., a fluoroethylene or fluoropropylene), such as a sulfonated tetrafluoroethylene-based fluoropolymer, such as Nafion®. In some embodiments, the ion-selective membrane has a hybrid structure having an organic component, such as any of the exemplary organic compositions above, in combination with an inorganic material, such as silicon (SiO₂). The hybrid structure can be produced by, for example, a sol gel process. The ion-selective membrane may alternatively be a composite, which includes separate layers of different membrane materials in contact with each other. The choice of membrane material may be dependent on the choice of redox active molecule, solvent, and other aspects of the redox flow battery in particular embodiments. For this reason, any of the specific classes or types of separator materials described above may be excluded or specifically selected in particular embodiments.

In some embodiments, the positive and negative sections may include a plurality of cells in electrical series defined by a stacked repetitive arrangement of a conductive intercell separator having generally a bipolar function, a first metal electrode, an ion exchange membrane, a second metal electrode and another conductive intercell separator. In one or more embodiments, the electrochemical stack comprises a plurality of electrochemical cells, each comprising a current collector for passage of electrical current and flow fields. In one or more embodiments, the stacked repetitive arrangement forming a battery stack comprises from 2 to 200 electrochemical cells.

Supplementary components may include an optional heat exchanger to dissipate heat due to resistive heating, an optional purge gas such as nitrogen or noble gases (xenon, argon, helium, neon, krypton) to exclude air and water vapor, a recirculation device such as a pump, tubing and manifolds used to direct the transport of the fluid electrolyte between one or more storage tank.

As a redox flow battery operates by flowing the electrolyte solutions over the respective electrodes, the redox flow battery includes circulation devices or pumps or other suitable devices for establishing flow of the electrolyte solutions. In addition to pumps, suitable devices may include a propeller designed for use within a liquid to establish fluid flow. Typically, the redox flow battery includes at least two flow devices, one designated for establishing flow in the positive section, and the other designated for establishing flow in the negative section.

In one embodiment, the electrolyte solutions contained in the positive and negative sections constitute the entire amount of electrolyte solution in the redox flow battery, i.e., no further reserve of electrolyte solution is hydraulically connected with the positive and negative sections. In another embodiment, the positive and negative sections are each connected by one or more conduits (e.g., a pipe or a channel) to storage (reservoir) tanks containing additional electrolyte solution. The storage tanks can advantageously serve to replenish spent electrolyte solution and increase the electrical capacity of the redox flow battery. The storage tanks can also advantageously serve to promote flow of the electrolyte solutions, particularly in an arrangement where the positive and negative sections are each connected to at least two storage tanks, in which case the redox flow battery would have at least four storage tanks.

In another aspect, the invention is directed to a method for storing and releasing electrical energy by use of the above-described redox flow battery. In the method, the redox flow battery is first charged by supplying electrical energy to the first metal electrode and the second metal electrode while the external load is not in electrical communication with the first metal electrode and the second metal electrode and while flowing the catholyte and anolyte, during which the organic molecule in the positive section is oxidized and the organic in the negative section is reduced. As such, inputted electrical energy has been converted and stored as electrochemical energy. The electrochemical energy is stored in the energetically uphill half reactions occurring in the positive and negative sections during the charging process. The resulting electrochemical potential energy is stored until a discharging process occurs, during which the stored electrochemical energy is converted to electrical energy while flowing the catholyte and anolyte, with concomitant reversal of the two half reactions (i.e., reduction in the positive section and oxidation in the negative section) to form the initial lower energy redox molecules present in both compartments before the charging process. Each half reaction generally operates by one or more one-electron processes, but they may also operate by multi-electron processes (e.g., one or more two-, three-, or four-electron processes), depending on the redox active molecule. The source of electrical energy in the charging process can be any desired source of electrical energy. In particular embodiments, the source of electrical energy is a renewable source of energy, such as wind, solar, or hydropower.

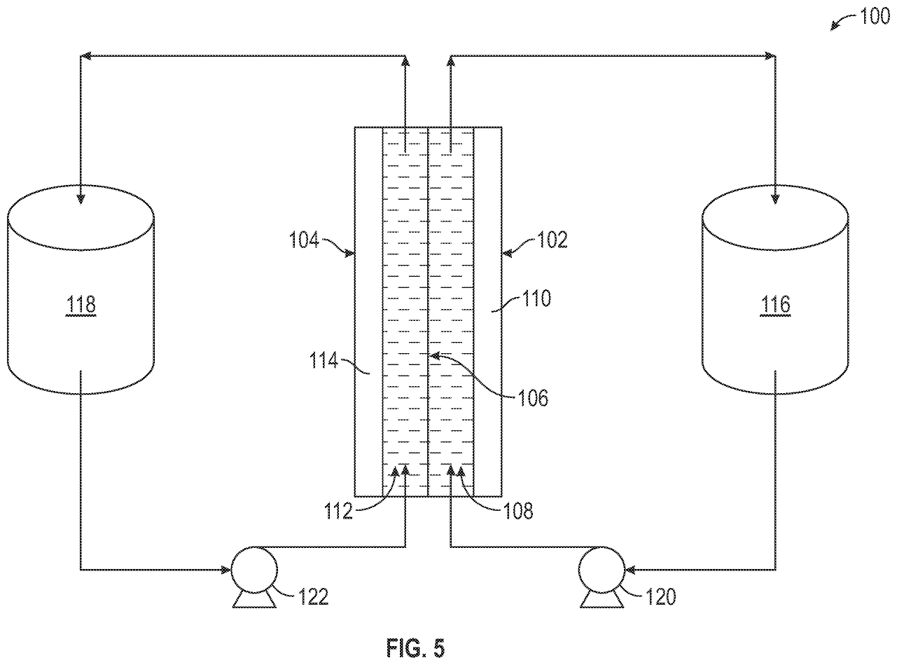

FIG. 5 is an example schematic of a redox flow battery system for energy storage 100. In the illustrated embodiment, the redox flow battery includes a positive section 102 and a negative section 104. A separator 106 (e.g., a porous separator or an ion selective membrane) separates the positive section 102 from the negative section 104. As illustrated, the positive section 102 includes a catholyte 108 (positive electrolyte solution) in contact with a first metal electrode 110, (the cathode or positive electrode). As further illustrated, the negative section 104 includes an anolyte 112 (negative electrolyte solution) in contact with a second metal electrode 114 (the anode or negative electrode). In this example, the energy is stored as dissolved ions within the solution, and the amount of energy for the system depends only on the amount of solution available in the catholyte tank 116 and the anolyte tank 118. Larger tanks will be able to store larger amounts of solution, leading to a longer duration discharge. Meanwhile, the power rating of the redox flow battery 100 is dictated by the cell-level design, such as flow path, the first metal electrode 110, and the second metal electrode 114. The flow rate is controlled by catholyte pump 120 for the catholyte 108 and anolyte pump 122 for the anolyte 112. While “positive” and “negative” are used to describe sections of the redox flow battery 100, these references do not require that the redox flow battery 100 be in operation and possess positive or negative polarity, but rather indicates suitability for operation to oxidize/reduce.

Accordingly, the present disclosure may provide redox electrochemical systems comprising high-voltage multivalent organic molecules comprising a pair of electron-donating groups and a pair of electron-withdrawing groups and methods of identifying these systems. The methods and systems may include any of the various features disclosed herein, including one or more of the following embodiments.

Statement 1. A system for energy storage comprising: a conjugated organic molecule comprising a pair of electron-donating groups and a pair of electron-withdrawing groups, wherein a first electron-donating group of the electron donating groups is one ring position from a first electron-withdrawing group of the electron-withdrawing groups, and wherein a second electron-donating group is one ring position from a second electron-withdrawing group of the electron-withdrawing groups; a positive section comprising a first metal electrode in contact with a catholyte comprising a portion of the conjugated organic molecule and a supporting electrolyte dissolved in an solvent; and a negative section comprising a second metal electrode in contact with an anolyte comprising an additional portion of the conjugated organic molecule and additional electrolyte dissolved in additional solvent.

Statement 2. The system of Statement 1, wherein the conjugated organic molecule has at least 2 electrochemically reversible redox states separated by at least 2 V.

Statement 3. The system of Statement 1 or 2, wherein the conjugated organic molecule in a neutral state is aromatic with two or fewer conjugated rings.

Statement 4. The system of any preceding Statement, wherein the conjugated organic molecule comprises a heterocyclic compound with two or fewer conjugated rings.

Statement 5. The system of any preceding Statement, wherein the heterocyclic compound comprises a diazene with 1 or 2 rings.

Statement 6. The system of any preceding Statement, wherein the conjugated organic molecule comprises a 2,3-dicyano-1,4-dialkylbenzene moiety.

Statement 7. The system of any preceding Statement, wherein the conjugated organic molecule comprises a 1,4-dialkyl-1,4-dihydroquinoxaline-2,3-dione moiety.

Statement 8. The system of any preceding Statement, wherein the conjugated organic molecule comprises N,N′-dialkyl phthalhydrazide.

Statement 9. The system of any preceding Statement, wherein the conjugated organic molecule comprises dialkyl 2,5-dialkoxyterephthalate moiety.

Statement 10. The system of any preceding Statement comprising from 2 to 200 electrochemical cells to form a battery stack, wherein each of the electrochemical cells comprises a corresponding positive section comprising the catholyte and a corresponding negative section comprising the anolyte.

Statement 11. The system of any preceding Statement, wherein the solvent and additional solvent are each an aprotic solvent selected from the group consisting of acetonitrile, dimethyl sulfoxide, sulfolane, dimethylacetamide, dimethylformamide, propylene carbonate, ethylene carbonate propyl sulfone, and butyl sulfone.

Statement 12. The system of any preceding Statement, wherein the positive section is separated from the negative section by a porous separator and/or an ion-selective membrane, and wherein the system further comprises a circulation device configured to circulate the catholyte or the anolyte from a storage tank to the positive section or the negative section.

Statement 13. A composition comprising: a multivalent redox-active organic molecule in a supporting electrolyte, wherein the multivalent redox active organic molecule comprises a pair of electron-donating groups and a pair of electron-withdrawing groups, wherein a first electron-donating group of the electron donating groups is one ring position from a first electron-withdrawing group, and wherein a second electron-donating group is one ring position from a second electron-withdrawing group.

Statement 14. The composition of Statement 13, wherein the pair of electron-donating groups is selected from the group consisting of alkoxy, dialkylamino, alkylamino, acyloxy, dialkylphosphino, and alkylthio groups; and wherein the pair of electron-withdrawing groups is selected from the group consisting of cyano, trifluoromethylsulfonyl, nitro, trihalomethyl, acyl, alkoxycarbonyl, and aminocarbonyl groups.

Statement 15. The composition of Statement 13 or 14, wherein the multivalent redox-active organic molecule has a pair of diketone substituents, and wherein the pair of electron-donating groups is selected from the group consisting of alkoxy, dialkylamino, alkylamino, acyloxy, dialkylphosphino, and alkylthio groups.

Statement 16. The composition of any of Statements 13-15, wherein the multivalent redox-active organic molecule is a diazene and, wherein the pair of electron-withdrawing groups is selected from the group consisting of alkoxy, dialkylamino, alkylamino, acyloxy, dialkylphosphino, and alkylthio groups.

Statement 17. The composition of any of Statements 13-16, wherein the multivalent redox-active organic molecule is a conjugated N,N′-dialkylazene, and wherein the pair of electron-withdrawing groups is selected from the group consisting of ketone, cyano, trifluoromethylsulfonyl, nitro, trihalomethyl, acyl, alkoxycarbonyl and aminocarbonyl groups.

Statement 18. A method for reversibly storing electrical energy in a symmetric redox flow battery with a unit cell potential equal to or greater than 3 volts, the method comprising: flowing a catholyte into contact with a first metal electrode in a positive section of the redox flow battery, wherein the catholyte comprises a single species of a conjugated organic molecule dissolved in a solvent, wherein the conjugated organic molecule comprises a pair of electron-donating groups and a pair of electron-withdrawing groups, wherein a first electron-donating group of the electron donating groups is one ring position from a first electron-withdrawing group, and wherein a second electron-donating group is one ring position from a second electron-withdrawing group; flowing an anolyte into contact with a second metal electrode in a negative section of the redox flow battery, wherein the negative section is separated from the positive section with an ion-transporting membrane, wherein the anolyte comprises an additional portion of the organic molecule dissolved in additional solvent; and supplying electrical energy to the first metal electrode and the second metal electrode while an external load is not in electrical communication with the first metal electrode and the second metal electrode to charge the redox flow battery while flowing the catholyte and flowing the anolyte.

Statement 19. The method of Statement 18, further comprising discharging the redox flow battery by establishing electrical communication between the external load with the first metal electrode and the second metal electrode while flowing the catholyte and flowing the anolyte.

Statement 20. The method of Statement 18 or 19, wherein the electron-donating group is selected from an electron-donating substituent pair selected from the group consisting of alkoxy, dialkylamino, alkylamino, acyloxy, dialkylphosphino and alkylthio groups; wherein the electron-withdrawing group is selected from the group consisting of cyano, trifluoromethylsulfonyl, nitro, trihalomethyl, acyl, alkoxycarbonyl, and aminocarbonyl groups; and wherein the conjugated organic molecule is selected from the group consisting of a substituted aromatic moiety with up to 2 aromatic rings, a heterocyclic diazene with up to 2 rings, a heterocylic tetrazine, and a heterocyclic quinonoid.

To facilitate a better understanding of the present invention, the following examples of certain aspects of some embodiments are given. In no way should the following examples be read to limit, or define, the entire scope of the disclosure.

### EXAMPLES

Electrochemical screening methods were used to screen the specific compounds. One type of screening method was cyclic voltammetry screening experiments performed in a nitrogen-purged 3-electrode beaker cell using 5 mM of the screened redox species, acetonitrile solvent, and 0.1 M of N-tetrabutylammonium hexafluorophosphate (TBAPF₆) as supporting electrolyte. A silver wire in 10 mM silver nitrate (AgNO₃)+0.1 M TBAPF₆ in acetonitrile with a double junction was used as the reference electrode. The reference electrode potential was measured to be −0.09 V versus a Ferrocene|Ferrocenium (Fc|Fc+) redox couple. Voltammetry data was recorded at 100 mV/s using a Princeton Applied Research Versastat MC potentiostat. Electrochemical data was corrected for solution resistance by a manual ohmic compensation of 80-130Ω as measured using electrochemical impedance spectroscopy (EIS).

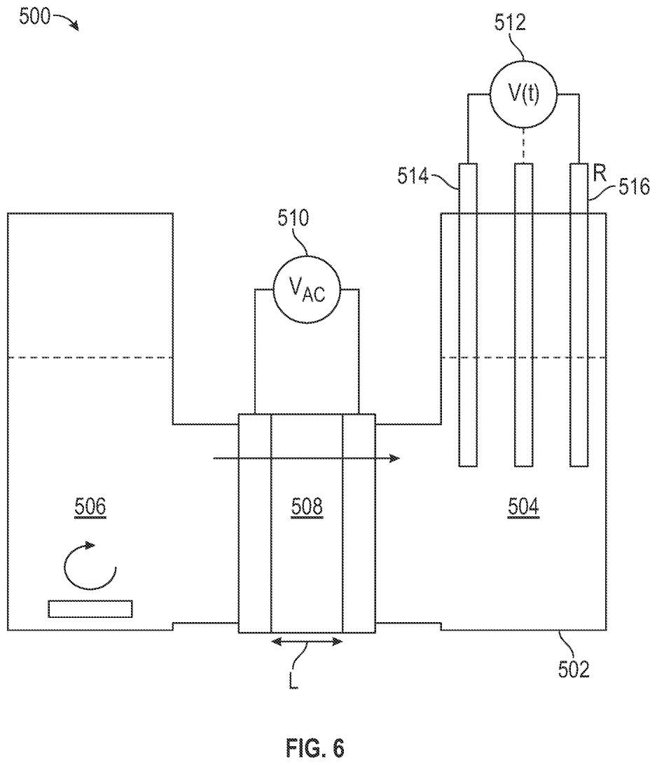

FIG. 6 is a schematic of a membrane characterization setup 500 to assess redox permeability and membrane ionic conductivity of one or more embodiments. Membrane crossover experiments were performed in an H-cell 502 with electrolyte 504 containing 0.5 M lithium tetrafluoroborate (LiBF₄) in acetonitrile and electrolyte 506 containing 0.1 M 10-[2(2 methoxyethoxy)ethyl]-10H-phenothiazine (MEEPT)+0.5 M LiBF₄ in acetonitrile. Cell 502 was assembled with an untreated ion-exchange membrane 508 and allowed to equilibrate in supporting electrolyte for at least 24 hours, and the membrane resistance was tracked using an Electrochemical Impedance Spectroscopy (EIS) 510 until the membrane impedance achieved a near-constant value. At this time, MEEPT corresponding to 0.1 M was dissolved to one of the H-cell chambers 502. Once fully dissolved, the crossover in the non-redox containing chamber was tracked using cyclic voltammetry 512 with its working electrode 514 and its reference electrode 516. The data was analyzed in accordance with the reference.

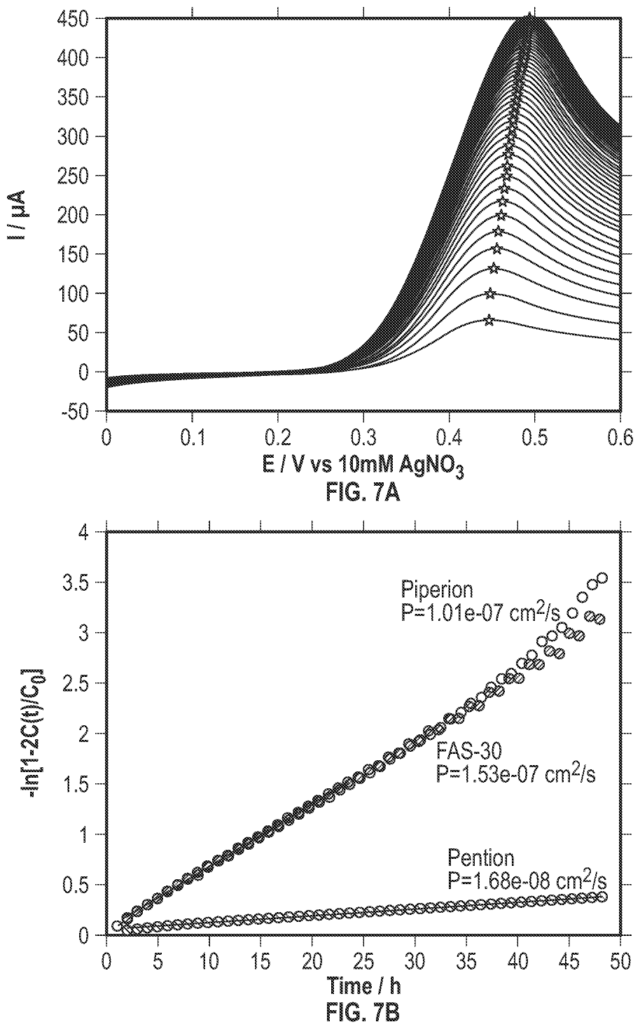

FIG. 7A are the cyclic voltammograms recorded with the membrane characterization setup of FIG. 6, recorded every hour at a scan rate of 25 mV/s within the voltage range from 0 V to 0.6 V vs Ag|10 mm AgNO₃. A plot of the anodic segment of the data was used to interpolate the MEEPT concentration using calibration voltammograms measured in the range 1-50 mM. The linear scanning voltametric peaks in FIG. 7A correspond to the MEEPT concentration in electrolyte 1 due to crossover from electrolyte 2. The data was analyzed in accordance with equation 6 from ACS Energy Lett. 2021, 6, 11, 3932-3943. The corresponding MEEPT permeability was measured and reported for a limited set of anion-conducting membranes in FIG. 7B (1.68×10⁻⁸-1.53×10⁻⁷ cm² s⁻¹), which are unsatisfactory asymmetric flow batteries but acceptable for a symmetric redox flow battery system. Consequently, managing permeability of the redox species at rates expected using commercial membranes (10⁻⁹ to 10⁻⁶ cm² s⁻¹) necessitates the use of symmetric redox molecules.

Computational screening methods were also used to screen the specific organic compounds. Cell potentials were predicted using results from density functional theory calculated using the Gaussian software package. The potentials were calculated as the energy difference between the single electron cationic and anionic forms for each molecule divided by Faraday's constant. These calculations were done with the B3LYP hybrid exchange-correlation functional, with a 6-31G* basis set for optimization and 6-311++G** basis set for energy calculation. Acetonitrile solvent was simulated using the solvation model based on density (SMD) method. The energy value for each molecule included the ground state energy, zero-point energy, thermal free energy, and solvation free energy were calculated. The same procedure was used for calculating half-cell potentials, except the energy difference was calculated as the more reduced form's energy subtracted by the more oxidized form's energy. This value was divided by Faraday's constant and a value of −4.5923 V was subtracted because in prior calculations it showed to reproduce potentials measured against a silver/silver nitrate reference electrode.

### Example 1

The following example was performed to illustrate the synthesis of 3,6-dimethoxy-1,2-dicyanobenzene and the corresponding electrochemical potential: 3,6-dihydroxyphthalonitrile (0.5 g, 3.12 mmol) was dissolved in acetone (10 mL). Then, potassium carbonate (1.08 g, 7.81 mmol) and methyl iodide (0.49 mL, 7.81 mmol) were added to this solution at room temperature and the reaction mixture was refluxed for 2 days. The reaction mixture was cooled to room temperature and the solvent removed under vacuum. Water (25 mL) was added to the residue, stirred for 10 minutes and the solids filtered and dried under vacuum to recover the crude material. The crude compound was dissolved in 100 mL acetonitrile and the undissolved material was removed by filtration. The solvent was evaporated to recover 3,6-dimethoxy-1,2-dicyanobenzene (88 mg, 15% yield).

The following synthesis is an alternative procedure. 3,6-dihydroxyphthalonitrile (5 g, 31.2 mmol) was mixed with 100 mL of 2-butanone at room temperature and 278 mmol (or 38.4 g) of potassium carbonate was added followed by 262 mmol of dimethyl sulfate (or 33.1 g). The reaction mixture was stirred at 110° C. for 17 hours and then cooled to room temperature and the solvent removed under vacuum. Water (250 mL) was added to the crude mixture and stirred. The precipitate was filtered and dried. 500 mL of acetonitrile was added to 5 grams of the crude compound and the undissolved residue filtered and the filtrate concentrated. 3 g of the product (46% yield) was recovered, which was ˜90% pure by GCMS. The product was re-dissolved in acetonitrile (˜1-2 Liter acetonitrile per 5 g of product) and the undissolved residue was filtered. The solvent was removed under vacuum and the product was triturated with hexane and ethyl acetate. The undissolved residue was filtered and the solvent was removed under vacuum to yield 3,6-dimethoxy-1,2-dicyanobenzene in ˜15% yield.

After preparation, the cyclic voltammetry was acquired as shown in FIG. 4A. FIG. 4A is the cyclic voltammograms of 5 mM 3,6-dimethoxy-1,2-dicyanobenzene+0.1 M TBAPF6 in acetonitrile acquired at 100 mV/s between −2.5 V to +1 V. FIG. 4B is the cyclic voltammograms of 5 mM 3,6-dimethoxy-1,2-dicyanobenzene+0.1 M TBAPF6 in acetonitrile acquired at 250 mV/s between +1 V and +1.9 V (dotted) and −2.5 V to 1.0 V (continuous line). When this is done with the exemplary molecules listed above, the molecule 3,6-dimethoxy-1,2-dicyanobenzene can be demonstrated to be redox-active and symmetric, with redox potentials, E_{1/2}, values of −1.957 V and 1.579 V, respectively.

### Example 2

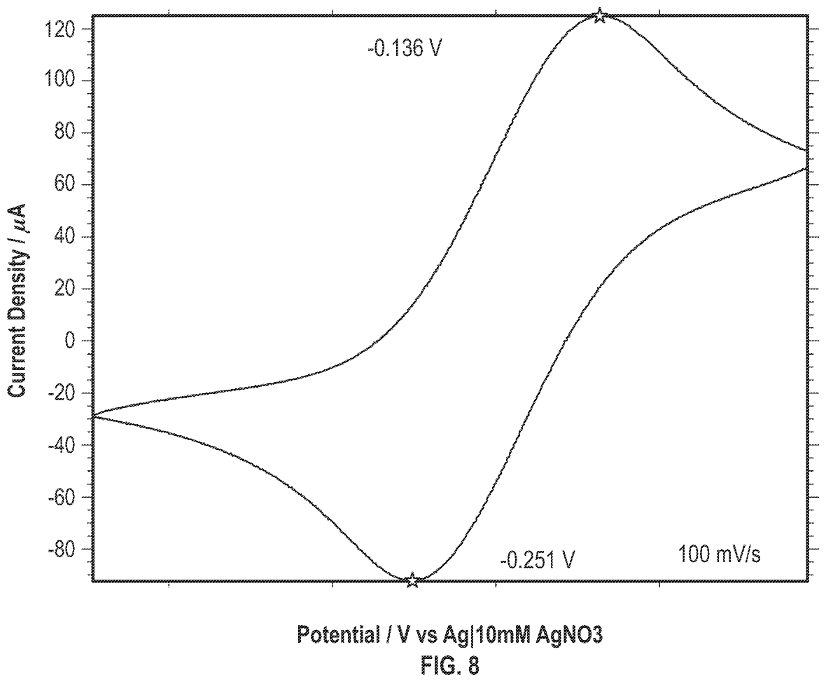

FIG. 8 is a cyclic voltammogram of 5 mM N, N′,N′-tetramethyl-p-phenylenediamine+0.1 M N-tetrabutylammonium hexafluorophosphate (TBAPF₆) in acetonitrile between −0.35 V to +0.1 V, wherein the redox potential, E_{1/2}, value of −0.1935 V.

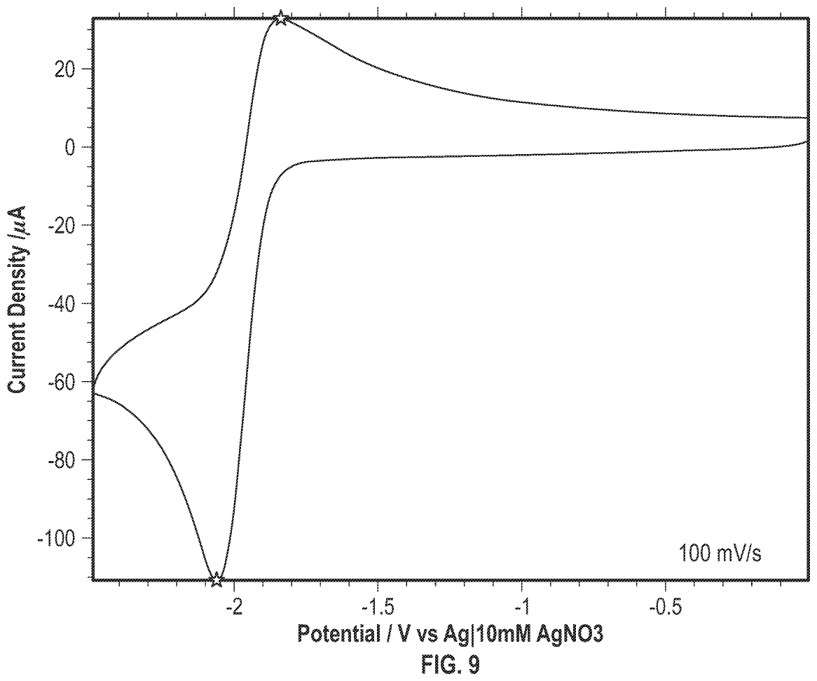

FIG. 9 is a cyclic voltammogram of 5 mM p-dicyanobenzene+0.1 M N-tetrabutylammonium hexafluorophosphate (TBAPF₆) in acetonitrile between −2.5 V to +0.0 V vs Ag|10 mM AgNO₃, wherein the redox potential, E_{1/2}, value was determined to be −0.1935 V.

An illustrative example of a synergistic symmetric molecule is 4,5-bis(dimethylamino)phthalonitrile. This compound can be synthesized from 4,5-dichlorophthalonitrile by refluxing with dimethylamine (≥2:1 ratio) in acetonitrile for up to 24 hours. As illustrated in Table 2 rows 9-10, 4,5-bis(dimethylamino)phthalonitrile has a predicted redox potential, E_{1/2}, value of XX V, which is much higher than the value of the asymmetric compounds listed in row 9 and row 10, respectively.|

### Example 3

The following example was performed to illustrate the synthesis of 6,7-difluoro-1,4-dimethyl-1,4-dihydroquinoxaline-2,3-dione, which is an example of a dihalogenated-1,4-dialkyl-1,4-dihydroquinoxaline-2,3-dione: 6,7-difluoro-1,4-dihydroquinoxaline-2,3-dione (500 mg, 2.5 mmol, 1 eq.) was dissolved in 20 mL of dimethyl formamide (DMF). K₂CO₃ (0.8 g, 6 mmol, 2 eq.) and iodomethane (800 mg, 6 mmol, 2 eq.) were added and the mixture was brought to 40° C. and stirred overnight (approximately 24 hours). The reaction mixture was diluted with water and extracted with dichloromethane (DCM) (3×20 mL). The combined organic layers were dried with magnesium sulfate (MgSO₄) and concentrated under reduced pressure to yield the crude product. The crude material was purified by silica gel chromatography eluting with ethyl acetate (EtOAc)/hexanes to yield 6,7-difluoro-1,4-dimethyl-1,4-dihydroquinoxaline-2,3-dione (0.38 g, 66%) as a beige solid.

### Example 4

The following example illustrates the synthesis of Dimethyl 2,5-dimethoxy terephthalate.

### Step-1: Dimethyl 2,5-dihydroxyterephthalate

To a stirred solution of 2,5-dihydroxyterephthalic acid (5 g, 25.2 mmol) in MeOH (100 mL) was added Conc·H₂SO₄ (Cat.) (0.067 mL, 1.262 mmol) and the resulting mixture was refluxed at 75° C. for 16 h. Upon completion of the reaction, the solvent was evaporated and residue was dissolved into DCM (250 mL) and stirred for 0.5 h. The precipitated solid was collected by using Buchner funnel and solid was washed with water (2×50 mL), dried under suction to afford dimethyl 2,5-dihydroxyterephthalate (5.3 g, 22.87 mmol, 91% yield) desired compound as yellow Solid. LCMS: m\z: 227.1 (M+H), RT (min): 1.734, Area (%): 97.590

### Step-2: Dimethyl 2,5-dimethoxyterephthalate

To a stirred solution of dimethyl 2,5-dihydroxyterephthalate (4.3 g, 19.01 mmol) in DMF (60 mL) was added K₂CO₃ (13.14 g, 95 mmol) followed by iodomethane (5.92 mL, 95 mmol) and the resulting mixture was refluxed at 80° C. for 16 h. Upon completion of the reaction, the reaction mixture was diluted with ice cold water (500 mL), neutralized with 1.5N HCl solution (50 mL). The precipitated solid was filtered by using Buchner funnel and residue was washed with water (2×250 mL) to afford the desired compound (4.68 g, 18.39 mmol, 97% yield) as Off white solid.

### Analytics:

LCMS: m\z: 255.0 (M+H), RT (min): 1.444, Area (%): 99.26

GCMS: m\z: 255.0 (M+H), RT (min): 6.757, Area (%): 99.90

Melting Range: 140.7° C.-142.3° C.

¹H-NMR (400 MHz, CDCl₃): δ 7.40 (s, 211), 3.93 (s, 611), 3.90 (s, 6H).

¹³C-NMR (100 MHz, CDCl₃): δ 165.9, 152.3, 123.9, 115.4, 56.7, 52.4.

### Example 5

The following examples illustrate the redox potential, E_{sym}^{cell}-E_{asym}^{cell} of various conjugated molecules with substituted aromatic and heterocyclic compounds indicating the synergistic benefit to the redox potential by proximally combining electron directing substituents.

TABLE 2
Redox Potentials of Organic Molecules and the Symmetric Molecule formed thereof indicating
the synergistic benefit to the redox potential by proximally combining electron directing substituents.

| Row | Redox molecule | $\begin{matrix}{E}_{\frac{1}{2}}^{0} \\ ( V vs Ag \vert {Ag}^{+} )\end{matrix}$ | Symmetric molecule | $\begin{matrix}{E}_{\frac{1}{2}}^{0} \\ ( V vs Ag \vert {Ag}^{+} )\end{matrix}$ | E_{sym}^{cell} − E_{asym}^{cell} (V) |
|---|---|---|---|---|---|
| 1 2 | 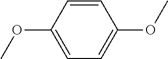 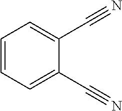 | 0.966 −2.014 | 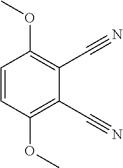 | 1.579 (measured), −1.957 (measured) | 0.556 |
| 3 4 | 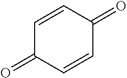 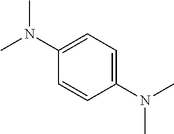 | −0.846 −0.194 | 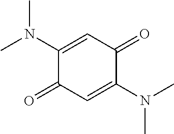 | +0.750 (predicted), −1.370 (predicted) | +1.475 |
| 5 6 | 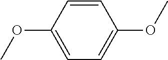 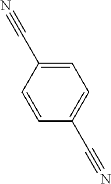 | 0.966 −1.942 | 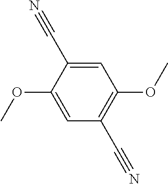 | +1.390 (predicted), −1.730 (predicted) | +0.182 |
| 7 8 | 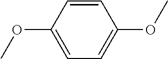 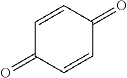 | 0.966 −0.846 | 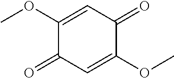 | +1.780 (predicted), −1.066 (measured) | +0.960 |
| 9 10 | 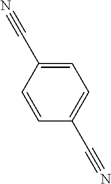 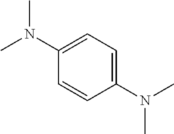 | −1.942 −0.194 | 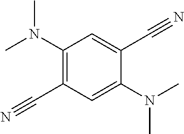 [SMILES: CN(C)c1cc(C#N)c(N(C)C)cc1C#N] | | |

In the first two rows of Table 2, the shift in redox potential, E_{sym}^{cell}-E_{asym}^{cell} of 1,4-dimethoxybenzene results from the addition of two electron-directing cyano substituents, which have a strong negative mesomeric effect (−M), resulting in a +0.556 V shift of the oxidative reaction. The associated cyclic voltammogram (100 mV/s) of 5 mM o-dicyanobenzene+0.1 M TBAPF6 in acetonitrile is shown in FIG. 3 from −2.5 V to 0 V. The chemical structures of the redox species are depicted in the first two rows of Table 2 above.

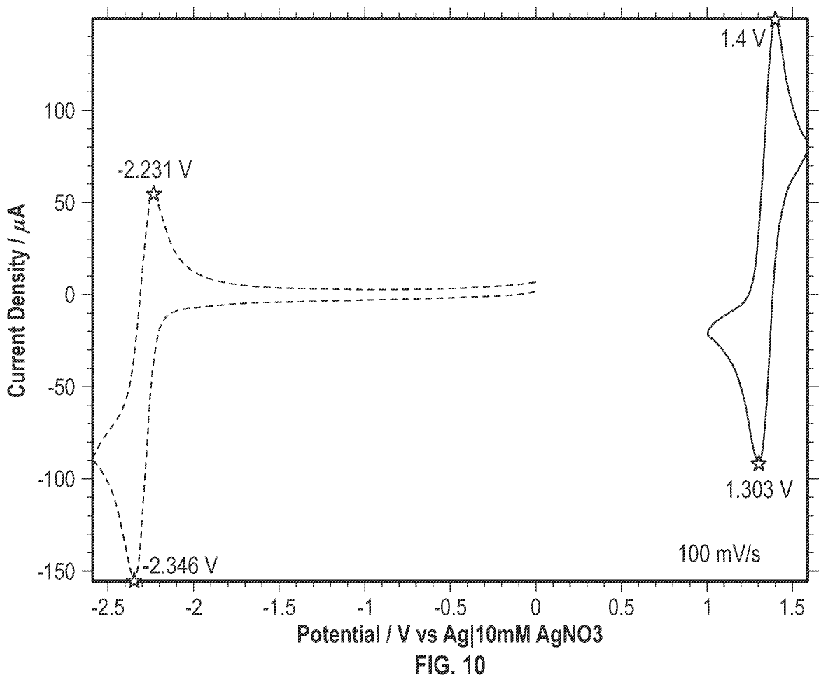

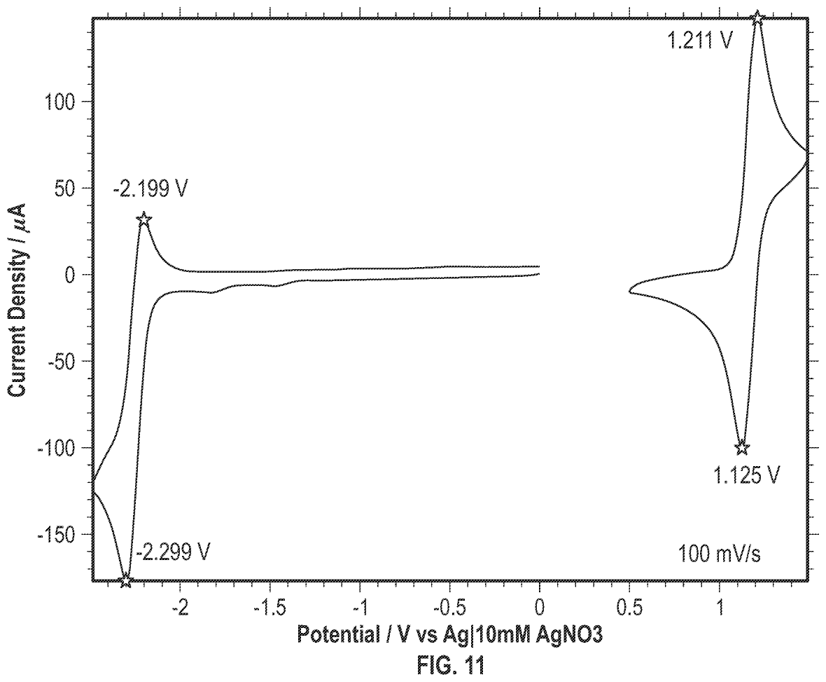

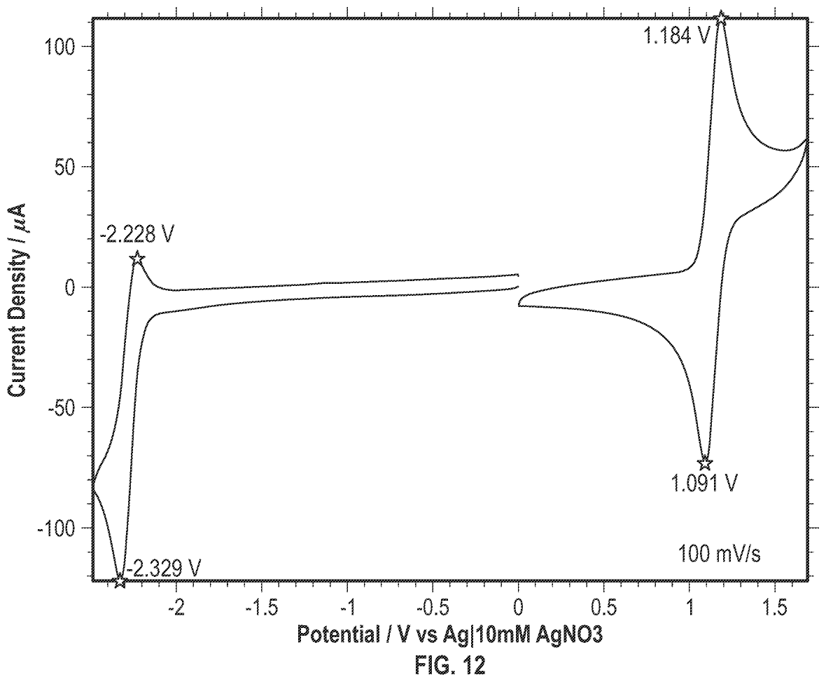

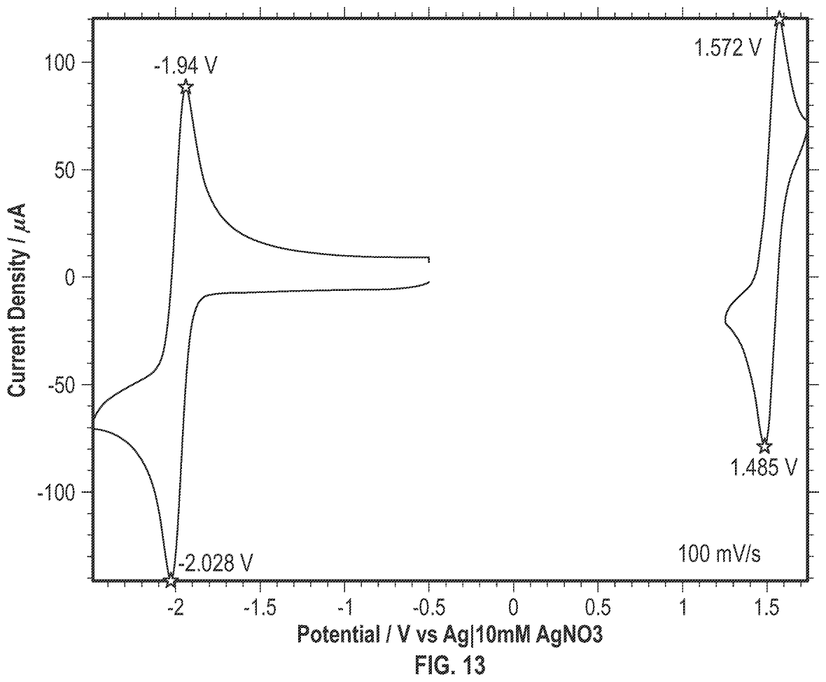

FIG. 10 is a cyclic voltammogram (100 mV/s) of 5 mM 6,7-difluoro-1,4-dimethyl-1,4-dihydroquinoxaline-2,3-dione+0.1 M N-tetrabutylammonium hexafluorophosphate (TBAPF₆) in acetonitrile between −2.6 V to +1.6 V.

While the magnitude of the synergistic benefit has not been exhaustively measured for every proposed synergistic molecule, we expect the boost in redox potential, measured by E_{sym}^{cell}-E_{asym}^{cell}, to be in the range 0.15 to 1.5 V based on the examples listed in Table 2 above.

### Example 6

The following examples are conjugated molecules with substituted aromatics comprising a pair of electron-donating groups and a pair of electron-withdrawing groups. The electrochemical open cell potential of some representative compounds from the substituted aromatic chemotype are represented in Table 3 below:

TABLE 3
Electrochemical Open Cell potential of Representative Compounds
from the Substituted Aromatic Chemotype.

| | Row | Biredox Molecule | E_{cell}⁰ (V) |
|---|---|---|---|
| SUBSTITUTED AROMATICS | 1 | 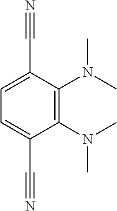 [SMILES: CN(C)c1c(C#N)ccc(C#N)c1N(C)C] | 2.35 (predicted) |
| | 2 | 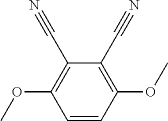 | 4.23, 3.54 (measured) 3.19 (predicted) |
| | 3 | 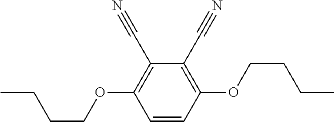 [SMILES: CCCCOc1ccc(OCCCC)c(C#N)c1C#N] | 3.52 (measured) 3.17 (predicted) |
| | 4 | 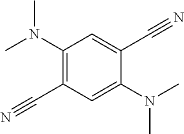 [SMILES: CN(C)c1cc(C#N)c(N(C)C)cc1C#N] | XX (predicted) |
| | 5 | 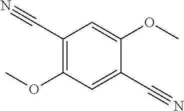 | 3.09 (predicted) |
| | 6 | 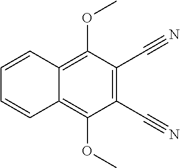 [SMILES: COc1c(C#N)c(C#N)c(OC)c2ccccc12] | 3.15 (predicted) |
| | 7 | 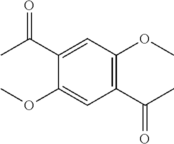 [SMILES: COc1cc(C(C)=O)c(OC)cc1C(C)=O] | 3.12 (measured) |
| | 8 | 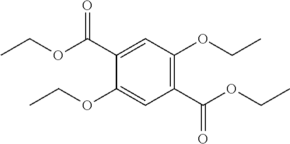 [SMILES: CCOC(=O)c1cc(OCC)c(C(=O)OCC)cc1OCC] | 3.35 (measured) |

The synergistic pairing of electron-directing substituent pairs leads to high electrochemical cell potential, defined in this disclosure as a cell potential equal to, or above, 2 V and up to 4.5 V included. From the electrochemical open cell potential of the representative compounds of Table 3, one can notice that the symmetric organic molecules of the present disclosure achieve outstanding cell potentials, E⁰_{cell}, with values well above 3 V. For instance, the measured cell potential is above 3.5 V in row 2 for 3,6-dimethoxy-1,2-dicyanobenzene resulting from the addition of one pair of cyano groups in ortho position (the cyano group is a strong electron withdrawing group with its negative mesomeric effect, −M) and one pair of methoxy groups in para position (the methoxy group is an electron donating group with its positive mesomeric effect, +M, but negative inductive effect, −I) on benzene. However, when the addition of the two cyano groups (+M) occurs in the para position and the addition of the two methoxy groups (−M) occurs on the para position as well as illustrated in the fifth row in Table 2 above with the cyano group in ortho position from the methoxy group, the predicted cell potential drops slightly to 3.09 V as compared to 3.17 V predicted for 2,3-dicyano-1,4-dibutoxybenzene and 3.19 V predicted for 3,6-dimethoxy-1,2-dicyanobenzene. 2,3-dicyano-1,4-dimethoxybenzene is one example of a 2,3-dicyano-1,4-dialkylbenzene, and the synergistic effect is expected to be observable in longer straight and branched chain substituted dialkoxybenzenes as well, as demonstrated by the 3,6-dibutoxy-1,2-dicyanobenzene reported in Table 3, Row 3.

One can also note that the predicted cell potential value for 2,3-dicyano-1,4-dimethoxynaphthalene (3.15 V in Table 3, Row 6) is also well above 3 V and is similar to the one for 3,6-dimethoxy-1,2-dicyanobenzene (3.19 V, in the third row). Therefore, the addition of an aromatic ring to 3,6-dimethoxy-1,2-dicyanobenzene can also result in a symmetric molecule with a promising redox potential. This molecule, 2,3-dicyano-1,4-dimethoxynaphthalene is an example of a 2,3-dicyano-1,4-dialkoxynaphthalene, and the synergistic effect is expected to be observable in longer straight and branched chain substituted dialkoxynaphthalenes as well.

If the cyano group is in the meta position as compared to the dimethyl amine group on the benzene, the predicted cell potential value is similar (2.59 V). However, if the pair of dimethyl amine groups are positioned in between the cyano group, the predicted cell potential value drops to 2.35 V as illustrated in the first row of Table 3. The difference of cell potential between the substituted aromatics containing a pair of dimethoxy groups vs a pair of dimethyl amine groups is clearly unexpected.

### Example 7

The following examples are substituted quinones comprising a pair of electron-donating groups and a pair of electron-withdrawing groups.

Table 4 below gives some electrochemical open cell potentials of some representative compounds from the substituted quinone chemotype:

TABLE 4
Electrochemical Open Cell Potentials of Representative Substituted
Quinone Chemotype.

| Row | Chemical Name | Biredox molecule | E_{cell}⁰ (V) |
|---|---|---|---|
| 1 | 2,5-dimethoxy-p- benzoquinone | 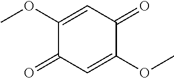 | 2.77 (predicted) |
| 2 | 2,5-bis (dimethylamino)-1,4- benzoquinone | 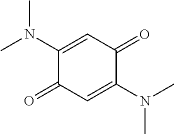 | 2.13 (predicted) |
| 3 | 2,3-bis(dimethylamino) naphthalene-1,4-dione | 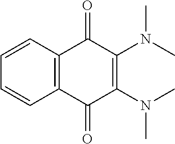 [SMILES: CN(C)C1=C(N(C)C)C(=O)c2ccccc2C1=O] | 1.27 (predicted) |

Unfortunately, the electrochemical open cell potentials are below 3 V. However, the synergistic pairing of the electron-directing substituent pairs in 2,5-dimethoxy-p-benzoquinone and 2,5-bis(dimethylamino)-1,4-benzoquinone exhibit an electrochemical cell potential high enough to be considered high cell potential (above 2 V) according to the definition in the present disclosure.

### Example 8

The following examples are heterocyclic quinonoids comprising a pair of electron-donating groups and a pair of electron-withdrawing groups. Heterocyclic quinonoids require the presence of at least one pair of electron-donating groups to be part of the conjugated system, exemplified by the alkylated nitrogen in Table 5 below:

TABLE 5
Chemical Structure and Open Cell Potential of Representative
Compounds of the Heterocyclic Quinonoid Chemotype.

| | Row | Biredox Molecule | E_{cell}⁰ (V) |
|---|---|---|---|
| HETEROCYCLIC QUINONOIDS | 1 | 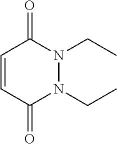 | 2.93 (predicted) |
| | 2 | 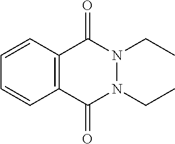 [SMILES: CCn1c(=O)c2ccccc2c(=O)n1CC] | 3.42 (measured) 3.18 (predicted) |
| | 3 | 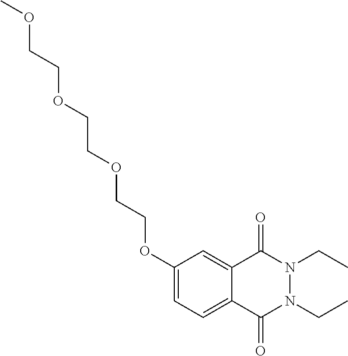 [SMILES: CCn1c(=O)c2ccc(OCCOCCOCCOC)cc2c(=O)n1CC] | 3.42 (measured) 3.28 (predicted) |
| | 4 | 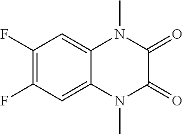 [SMILES: Cn1c(=O)c(=O)n(C)c2cc(F)c(F)cc21] | 3.64 (measured) 3.47 (predicted) |

From the second row of Table 5, one can notice that the addition of a pair of ethyl groups on each N position of the 2,3-dihydrophthalazine-1,4-dione leads to a measured open cell potential of 3.42 V. One should note ketones are strong electron-withdrawing groups while alkyl groups have a positive inductive effect. Therefore, the free pair of electrons of the nitrogen and the oxygen's ability to carry a negative charge can help stabilize the conjugated form of the 2,3-dihydrophthalazine-1,4-dione. One should also note that the pair of electron-withdrawing groups (in para position) is separated by the pair of groups with a positive inductive effect. Finally, the addition of an ether group (electron-donating group with its positive mesomeric effect, +M, but negative inductive effect, −I) in the 8^{th} position does not change the measured open cell potential of 3.42 V as evidenced in the 2^{nd} and 3^{rd} row of Table 5 above.

In the fourth row of Table 5 above, one can notice the measured open cell potential of the 7,8-difluoro-1,4-dimethyl-1,4-dihydroquinoxaline-2,3-dione is outstanding at 3.64 V.

### Example 8

The following examples are substituted di-heterocycles. When the heteroatom is selected from the Group V elements (specifically N or P), the substituted di-heterocycles require the presence of one pair of electron-donating groups, represented by R1, and one pair of electron-withdrawing heteroatoms in the conjugated system.

When the heteroatom is selected from the Group VI elements (specifically S), the substituted di-heterocycles require the presence of one pair of electron-withdrawing groups, represented by R2, and one pair of electron-donating heteroatoms in the cyclic conjugated system.

Optional non-directing groups (alkyl, halogen, aryl, glycol) may be included to reduce the melting point or improve the stability of the charged radical by introducing steric stabilization.

The examples in Table 6 below illustrate the structures and open circuit potentials of some representative compounds from the di-heterocyclic chemotype.

TABLE 6
Structures and Open Circuit Potentials of Representatives
Di-Heterocyclic Chemotype.

| | Row | Biredox Molecule | E_{cell}⁰ (V) |
|---|---|---|---|
| SUBSTITUTED DI-HETEROCYCLES | 1 | 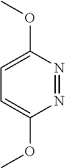 | 3.94 (predicted) |
| | 2 | 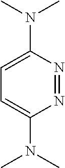 | 2.72 (predicted) |
| | 3 | 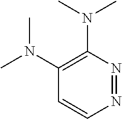 | 3.15 (predicted) |
| | 4 | 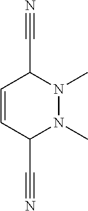 | 4.31 (predicted) |
| | 5 | 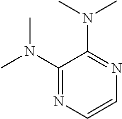 | 2.97 (predicted |
| | 6 | 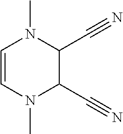 | 2.74 (predicted) |
| | 7 | 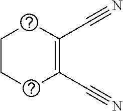 | 3.03 (predicted) |
| | 8 | 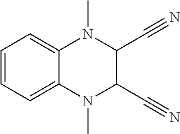 [SMILES: CN1c2ccccc2N(C)C(C#N)C1C#N] | 3.24 (predicted) |
| | 9 | 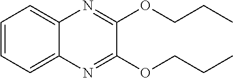 [SMILES: CCCOc1nc2ccccc2nc1OCCC] | 3.63 (measured) 3.66 (predicted) |
| | 10 | 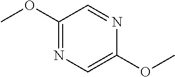 | 3.90 V (measured) |

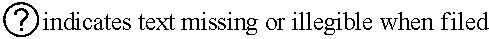

From the first row of Table 6 above, one can notice that the addition of a pair of methoxy groups (electron-donating groups with their positive mesomeric effect, +M, but negative inductive effect, −I) in the para position from one another and in the ortho position from the nitrogen of the pyridazine leads to a predicted open circuit potential of 3.94 V, which is considered to be a high electrochemical cell potential.

From the second and third rows, one can notice that the influence of the position of the dimethyl amine group (electron-donating group with its positive mesomeric effect, +M, but negative inductive effect, −I) in ortho or meta position from the nitrogen of the pyridazine does not seem to have dramatic consequences with values of predicted open circuit potential of 3.21 V in meta position (or when the dimethyl amine groups are on the opposite side of the nitrogen atoms) in the third row vs 3.15 V when the dimethyl amine are in ortho and meta positions in the fourth row of Table 6 above.

In the fourth row, it should be noted that the addition of a pair of cyano groups (strong electron withdrawing group with their negative mesomeric effect, −M) in para position of the 1,2-diazin-5-ene along with the addition of a methyl group on each nitrogen leads to a predicted open circuit potential of 4.31 V, which is extraordinary.

In the fifth row of Table 6, the addition of a pair of dimethyl amine groups in ortho position, or in between the two nitrogens of the pyrazine leads to a predicted open circuit potential of 2.97 V, which is considered high electrochemical cell potential.

In the seventh row of Table 6, the addition of a pair of cyano groups in ortho position, or in between the two sulfur atoms of the 1,4-dithi-2-ene leads to a predicted open circuit potential of 3.03 V.

In the eighth row of Table 6, the predicted value of the open circuit potential of 2,3-bis(cyano)-1,4-dimethyl-quinoxaline is 3.24 V, which is well above the prior art.

In the ninth row of Table 6, it should also be noted that the addition of a pair of propyl ether groups on quinoxaline to give a 2,3-di(n-propoxy)quinoxaline leads to a measured open circuit potential of 3.63 V, which is close to the predicted result.

### Example 9

The following examples are tetra-heterocycles comprising a pair of electron-donating groups and a pair of electron-withdrawing groups. Tetra-heterocycles requires the presence of one pair of electron-donating groups, represented by R₁ and one pair of electron-withdrawing groups, represented by R₂ in Table 7 below that illustrates the structures and open circuit potentials for some specific examples:

TABLE 7
Structures and Open Circuit Potentials for Some Specific
Examples from the Tetra-Heterocycle Chemotype.

| TETRA- | | | |
|---|---|---|---|
| HETERO- | | | |
| CYCLES | Row | Biredox Molecule | E_{cell}⁰ (V) |
| | 1 | 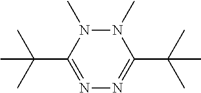 [SMILES: CN1C(C(C)(C)C)=NN=C(C(C)(C)C)N1C] | 3.33 (predicted) |
| | 2 | 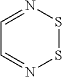 | 2.33 (predicted) |

As appropriate, the heteroatom may also be responsible for the electron density of the conjugated system. Additional weakly or non-electron-directing substituents may be optionally included, represented as R₃ and R₄.

In Row 1 of Table 7, a methyl group (R₁) is added to each nitrogen of a tetrazine while a tert-butyl group (R₄) is added to each carbon in between (ortho position) leading to a predicted open circuit potential of 3.33 V, which is considered as a high electrochemical cell potential.

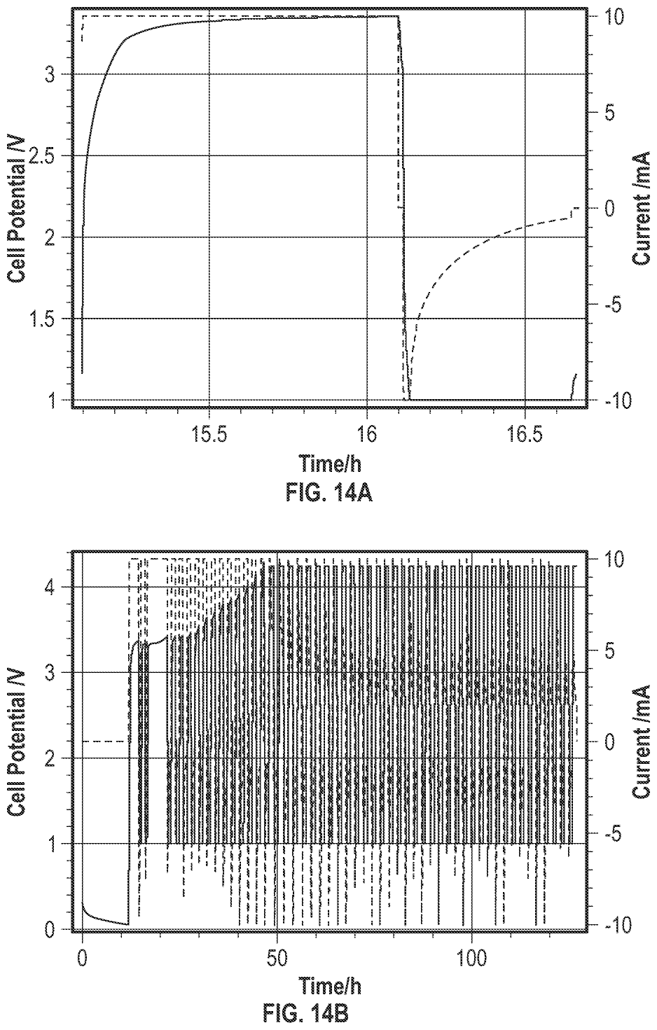

Exemplary operation of a 3,6-dimethoxy-1,2-dicyanobenzene redox flow battery: a redox flow battery setup was assembled comprising of a single electrochemical cell stack with gold-plated current collectors, graphite flow fields (25 cm² area), carbon felt electrodes, cation exchange membrane, peristaltic pump and associated vessels to contain the redox species. Acetonitrile was used as the solvent and up to 0.5 M TBAPF₆ was used as the supporting electrolyte. Battery cycling experiments were performed in a nitrogen inert glovebox with less than 1 part per million, or ppm, of oxygen and water respectively. The first cycle of a 10 mM 3,6-dimethoxy-1,2-dicyanobenzene symmetric flow battery is represented in FIG. 14A. 50 cycles of a 10 mM 3,6-dimethoxy-1,2-dicyanobenzene symmetric flow battery are represented in FIG. 14B. This indicates the stable cycling of a non-aqueous redox flow battery system.

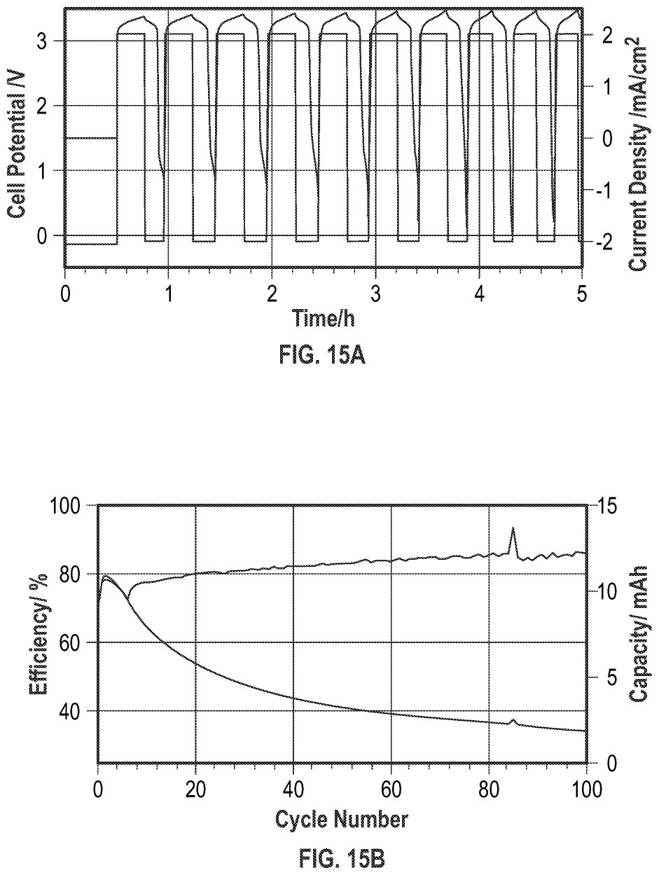

Exemplary operation of a Diethyl 2,5-diethoxy terephthalate redox flow battery: a redox flow battery setup was assembled comprising of a single electrochemical cell stack with gold-plated current collectors, graphite flow fields (25 cm² area), carbon felt electrodes, cation exchange membrane, peristaltic pump and associated vessels to contain the redox species. Acetonitrile was used as the solvent and up to 0.5 M TEAPF₆ was used as the supporting electrolyte. Battery cycling experiments were performed in a nitrogen inert glovebox with less than 1 part per million, or ppm, of oxygen and water respectively. The first cycle of a 25 mM diethyl 2,5-diethoxy terephthalate symmetric flow battery is represented in FIG. 15A. The discharge capacity fade and coulombic efficiency of the first 100 cycles of a 25 mM 3,6-dimethoxy-1,2-dicyanobenzene symmetric flow battery are represented in FIG. 15B. This indicates the stable cycling of a non-aqueous redox flow battery system.

While the disclosure has been described with respect to a number of embodiments and examples, those skilled in the art, having benefit of this disclosure, will appreciate that other embodiments can be devised which do not depart from the scope and spirit of the disclosure as disclosed herein. Although individual embodiments are discussed, the present disclosure covers all combinations of all those embodiments.

While compositions, methods, and processes are described herein in terms of “comprising,” “containing,” “having,” or “including” various components or steps, the compositions and methods can also “consist essentially of” or “consist of” the various components and steps. The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the disclosure, additionally, they do not exclude impurities and variances normally associated with the elements and materials used.

All numerical values within the detailed description are modified by “about” the indicated value, and take into account experimental error and variations that would be expected by a person having ordinary skill in the art.

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

What is claimed is:

1. A system for energy storage comprising:
a conjugated organic molecule comprising a pair of electron-donating groups and a pair of electron-withdrawing groups, wherein a first electron-donating group of the electron donating groups is one ring position from a first electron-withdrawing group of the electron-withdrawing groups, and wherein a second electron-donating group is one ring position from a second electron-withdrawing group of the electron-withdrawing groups;
a positive section comprising a first metal electrode in contact with a catholyte comprising a portion of the conjugated organic molecule and a supporting electrolyte dissolved in a solvent; and
a negative section comprising a second metal electrode in contact with an anolyte comprising an additional portion of the conjugated organic molecule and additional electrolyte dissolved in additional solvent.

2. The system of claim 1, wherein the conjugated organic molecule has at least 2 electrochemically reversible redox states separated by at least 2 V.

3. The system of claim 1, wherein the conjugated organic molecule in a neutral state is aromatic with two or fewer conjugated rings.

4. The system of claim 1, wherein the conjugated organic molecule comprises a heterocyclic compound with two or fewer conjugated rings.

5. The system of claim 4, wherein the heterocyclic compound comprises a diazene with 1 or 2 rings.

6. The system of claim 1, wherein the conjugated organic molecule comprises a 2,3-dicyano-1,4-dialkylbenzene moiety.

7. The system of claim 1, wherein the conjugated organic molecule comprises a 1,4-dialkyl-1,4-dihydroquinoxaline-2,3-dione moiety.

8. The system of claim 1, wherein the conjugated organic molecule comprises N,N′-dialkyl phthalhydrazide.

9. The system of claim 1, wherein the conjugated organic molecule comprises dialkyl 2,5-dialkoxyterephthalate moiety.

10. The system of claim 1 comprising from 2 to 200 electrochemical cells to form a battery stack, wherein each of the electrochemical cells comprises a corresponding positive section comprising the catholyte and a corresponding negative section comprising the anolyte.

11. The system of claim 1, wherein the solvent and additional solvent are each an aprotic solvent selected from the group consisting of acetonitrile, dimethyl sulfoxide, sulfolane, dimethylacetamide, dimethylformamide, propylene carbonate, ethylene carbonate propyl sulfone, and butyl sulfone.

12. The system of claim 1, wherein the positive section is separated from the negative section by a porous separator and/or an ion-selective membrane, and wherein the system further comprises a circulation device configured to circulate the catholyte or the anolyte from a storage tank to the positive section or the negative section.

13. A composition comprising:
a multivalent redox-active organic molecule in a supporting electrolyte, wherein the multivalent redox active organic molecule comprises a pair of electron-donating groups and a pair of electron-withdrawing groups, wherein a first electron-donating group of the electron donating groups is one ring position from a first electron-withdrawing group, and wherein a second electron-donating group is one ring position from a second electron-withdrawing group.

14. The composition of claim 13:
wherein the pair of electron-donating groups is selected from the group consisting of alkoxy, dialkylamino, alkylamino, acyloxy, dialkylphosphino, and alkylthio groups; and
wherein the pair of electron-withdrawing groups is selected from the group consisting of cyano, trifluoromethylsulfonyl, nitro, trihalomethyl, acyl, alkoxycarbonyl, and aminocarbonyl groups.

15. The composition of claim 13, wherein the multivalent redox-active organic molecule has a pair of diketone substituents, and wherein the pair of electron-donating groups is selected from the group consisting of alkoxy, dialkylamino, alkylamino, acyloxy, dialkylphosphino, and alkylthio groups.

16. The composition of claim 13, wherein the multivalent redox-active organic molecule is a diazene and, wherein the pair of electron-withdrawing groups is selected from the group consisting of alkoxy, dialkylamino, alkylamino, acyloxy, dialkylphosphino, and alkylthio groups.

17. The composition of claim 13, wherein the multivalent redox-active organic molecule is a conjugated N,N′-dialkylazene, and wherein the pair of electron-withdrawing groups is selected from the group consisting of ketone, cyano, trifluoromethylsulfonyl, nitro, trihalomethyl, acyl, alkoxycarbonyl and aminocarbonyl groups.

18. A method for reversibly storing electrical energy in a symmetric redox flow battery with a unit cell potential equal to or greater than 3 volts, the method comprising:
flowing a catholyte into contact with a first metal electrode in a positive section of the redox flow battery, wherein the catholyte comprises a single species of a conjugated organic molecule dissolved in a solvent, wherein the conjugated organic molecule comprises a pair of electron-donating groups and a pair of electron-withdrawing groups, wherein a first electron-donating group of the electron donating groups is one ring position from a first electron-withdrawing group, and wherein a second electron-donating group is one ring position from a second electron-withdrawing group;
flowing an anolyte into contact with a second metal electrode in a negative section of the redox flow battery, wherein the negative section is separated from the positive section with an ion-transporting membrane, wherein the anolyte comprises an additional portion of the organic molecule dissolved in additional solvent; and
supplying electrical energy to the first metal electrode and the second metal electrode while an external load is not in electrical communication with the first metal electrode and the second metal electrode to charge the redox flow battery while flowing the catholyte and flowing the anolyte.

19. The method of claim 18, further comprising discharging the redox flow battery by establishing electrical communication between the external load with the first metal electrode and the second metal electrode while flowing the catholyte and flowing the anolyte.

20. The method of claim 18:
wherein the electron-donating group is selected from an electron-donating substituent pair selected from the group consisting of alkoxy, dialkylamino, alkylamino, acyloxy, dialkylphosphino and alkylthio groups;
wherein the electron-withdrawing group is selected from the group consisting of cyano, trifluoromethylsulfonyl, nitro, trihalomethyl, acyl, alkoxycarbonyl, and aminocarbonyl groups; and
wherein the conjugated organic molecule is selected from the group consisting of a substituted aromatic moiety with up to 2 aromatic rings, a heterocyclic diazene with up to 2 rings, a heterocylic tetrazine, and a heterocyclic quinonoid.
